(19) United States
(12) Patent Application Publication
(10) Pub. No.: US 2024/0105053 A1
(43) Pub. Date: Mar. 28, 2024

(54) ROAD SURVEILLANCE SYSTEM, ROAD SURVEILLANCE METHOD, AND NON-TRANSITORY STORAGE MEDIUM

(71) Applicant: NEC Corporation, Tokyo (JP)

(72) Inventors: Shin Tominaga, Tokyo (JP); Yusuke Imai, Tokyo (JP); Kazutoshi Sagi, Tokyo (JP); Yuzo Senda, Tokyo (JP)

(21) Appl. No.: 18/237,119

(22) Filed: Aug. 23, 2023

(30) Foreign Application Priority Data
Sep. 27, 2022 (JP) 2022-154132

(51) Int. Cl. G08G 1/01; G06V 20/54; G08G 1/017

(52) U.S. Cl. CPC G08G 1/0133; G06V 20/54; G08G 1/0116; G08G 1/017; G06V 2201/08

(57) ABSTRACT

To improve efficiency of road surveillance, a road surveillance system includes a detection unit 122 and a processing unit 134. The detection unit 122 detects a road state being a state of an object on a road by processing an image in which the road is captured. The processing unit 134 performs, when the road state satisfies a first criterion, any of notification processing of making a notification of the road state that satisfies the first criterion according to notification setting related to the notification, and change-related processing related to a change in the notification setting, based on whether a second criterion is satisfied. The second criterion is a criterion related to a determination result of whether the road state satisfies the first criterion.

### RELATED ART

The present invention relates to a road surveillance system, a road surveillance apparatus, a road surveillance method, and a non-transitory storage medium.

### BACKGROUND ART

Various techniques for notifying a user by distinguishing an event occurring on a road have been proposed.

For example, in a road abnormality determining system described in PTL 1 (Japanese Patent Application Publication No. 2022-009968), a probe car apparatus included in a probe car detects road state information Irc, and the road state information Irc is transmitted from the probe car to a data analysis server included in a vehicle operation center.

The data analysis server described in PTL 1 analyzes the road state information Irc, determines whether an abnormality occurs on a road, and displays a determination result and the road state information Irc on an operator terminal when it is determined that the abnormality occurs on the road. An operator determines whether the road is abnormal by viewing the road state information Irc displayed on the operator terminal, and further determines whether the road cannot be passed when the road is determined to be abnormal.

PTL 1 describes that examples of a classification of a road abnormality include natural congestion, presence of a fallen object, a lane restriction due to a traffic accident, and a lane restriction due to road construction.

### SUMMARY

However, in general, an event such as a road abnormality described in PTL 1 may continue over a period of time to some extent. Thus, in the technique described in PTL 1, the data analysis server may repeatedly determine that the same event on a road is abnormal, and a determination result thereof may continue to be displayed on the operator terminal.

In such a case, even a determination result of the data analysis server is correct, an operator repeatedly confirms a known road abnormality by viewing the display, and efficiency of road surveillance may decrease.

One example of an object of the present invention is, in view of the problem described above, to provide a road surveillance system, a road surveillance method, a non-transitory storage medium and the like that solve a challenge to improve efficiency of road surveillance.

One aspect of the present invention provides a road surveillance system including:
a detection means for detecting a road state being a state of an object on a road by processing an image in which the road is captured; and
a processing means for performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

One aspect of the present invention provides a road surveillance apparatus including:
a road state acquisition means for acquiring state information including a road state being a state of an object on a road; and
a processing means for performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

One aspect of the present invention provides a road surveillance method including, by one or more computers:
acquiring state information including a road state being a state of an object on a road; and
performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

One aspect of the present invention provides a program causing one or more computers to execute:
acquiring state information including a road state being a state of an object on a road; and
performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

According to one aspect of the present invention, efficiency of road surveillance can be improved.

### BRIEF DESCRIPTION OF THE DRAWINGS

FIG. 1 is a diagram schematically illustrating an overview of a road surveillance system according to an example embodiment 1.

FIG. 2 is a diagram illustrating an overview of a road surveillance apparatus according to the example embodiment 1.

FIG. 3 is a flowchart illustrating an overview of a road surveillance method according to the example embodiment 1.

FIG. 4 is a diagram illustrating a configuration example of the road surveillance system according to the example embodiment 1.

FIG. 5 is a diagram illustrating a configuration example of image information according to the example embodiment 1.

FIG. 6 is a diagram illustrating a functional configuration example of an image processing apparatus according to the example embodiment 1.

FIG. 7 is a diagram illustrating a configuration example of state information according to the example embodiment 1.

FIG. 8 is a diagram illustrating a functional configuration example of the road surveillance apparatus according to the example embodiment 1.

FIG. 9 is a diagram illustrating a functional configuration example of a processing unit according to the example embodiment 1.

FIG. 10 is a diagram illustrating one example of notification setting according to the example embodiment 1.

FIG. 11 is a diagram illustrating a physical configuration example of a capturing apparatus according to the example embodiment 1.

FIG. 12 is a diagram illustrating a physical configuration example of the image processing apparatus according to the example embodiment 1.

FIG. 13 is a flowchart illustrating an example of capturing processing according to the example embodiment 1.

FIG. 14 is a diagram illustrating one example of a road R to be captured.

FIG. 15 is a diagram illustrating one example of image information IMD including an image IM1 in which the road R illustrated in FIG. 14 is captured.

FIG. 16 is a flowchart illustrating one example of image processing according to the example embodiment 1.

FIG. 17 is a diagram illustrating one example of state information STD generated in step S123.

FIG. 18 is a flowchart illustrating one example of surveillance processing according to the example embodiment 1.

FIG. 19 is a diagram illustrating one example of a notification screen according to the example embodiment 1.

FIG. 20 is a diagram illustrating one example of a first confirmation screen according to the example embodiment 1.

FIG. 21 is a diagram illustrating a functional configuration example of a processing unit according to an example embodiment 2.

FIG. 22 is a diagram illustrating one example of a notification change rule according to the example embodiment 2.

FIG. 23 is a flowchart illustrating one example of surveillance processing according to the example embodiment 2.

FIG. 24 is a diagram illustrating one example of notification setting after a change according to the example embodiment 2.

FIG. 25 is a diagram illustrating a functional configuration example of a processing unit according to an example embodiment 3.

FIG. 26 is a flowchart illustrating one example of surveillance processing according to the example embodiment 3.

FIG. 27 is a diagram illustrating one example of a second confirmation screen according to the example embodiment 3.

FIG. 28 is a diagram illustrating a configuration example of a road surveillance system according to an example embodiment 4.

FIG. 29 is a diagram illustrating a functional configuration example of a processing unit according to an example embodiment 5.

FIG. 30 is a diagram illustrating one example of notification setting according to the example embodiment 5.

FIG. 31 is a flowchart illustrating one example of notification setting processing according to the example embodiment 5.

FIG. 32 is a flowchart illustrating one example of surveillance processing according to the example embodiment 5.

### DETAILED DESCRIPTION

Hereinafter, example embodiments of the present invention will be described by using drawings. Note that, in all of the drawings, a similar component has a similar reference sign, and description thereof will be appropriately omitted.

### EXAMPLE EMBODIMENT 1

### (Overview)

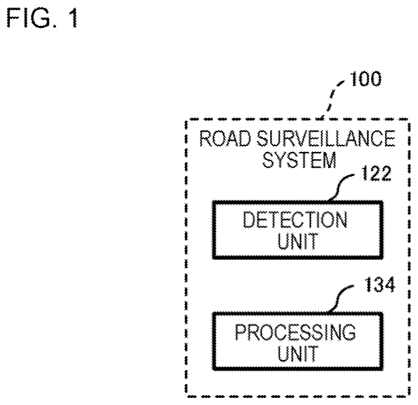

FIG. 1 is a diagram schematically illustrating an overview of a road surveillance system 100 according to an example embodiment 1. The road surveillance system includes a detection unit 122 and a processing unit 134.

The detection unit 122 detects a road state being a state of an object on a road by processing an image in which the road is captured. The processing unit 134 performs, when the road state satisfies a first criterion, any of notification processing of making a notification of the road state that satisfies the first criterion according to notification setting related to the notification, and change-related processing related to a change in the notification setting, based on whether a second criterion related to a determination result of whether the road state satisfies the first criterion is satisfied.

The road surveillance system 100 can improve efficiency of road surveillance.

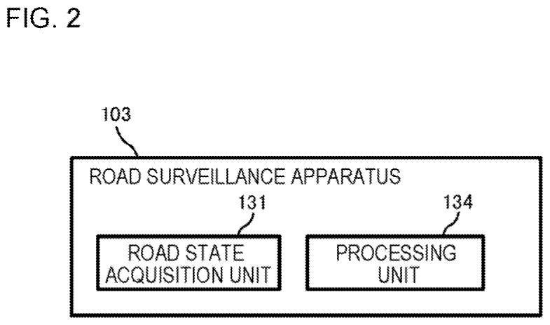

FIG. 2 is a diagram illustrating an overview of a road surveillance apparatus 103 according to the example embodiment 1. The road surveillance apparatus 103 is one example of an apparatus constituting the road surveillance system 100. The road surveillance apparatus 103 includes a road state acquisition unit 131 and the processing unit 134 described above.

The road state acquisition unit 131 acquires state information including a road state being a state of an object on a road. As described above, the processing unit 134 performs, when the road state satisfies a first criterion, any of notification processing of making a notification of the road state that satisfies the first criterion according to notification setting related to the notification, and change-related processing related to a change in the notification setting, based on whether a second criterion related to a determination result of whether the road state satisfies the first criterion is satisfied.

The road surveillance apparatus 103 can improve efficiency of road surveillance.

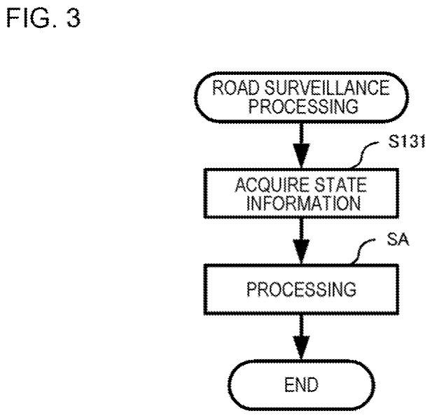

FIG. 3 is a flowchart illustrating an overview of a road surveillance method according to the example embodiment 1.

The road state acquisition unit 131 acquires state information including a road state being a state of an object on a road (step S131).

The processing unit 134 performs, when the road state satisfies a first criterion, any of notification processing of making a notification of the road state that satisfies the first criterion according to notification setting related to the notification, and change-related processing related to a change in the notification setting, based on whether a second criterion related to a determination result of whether the road state satisfies the first criterion is satisfied (step SA).

The road surveillance method can improve efficiency of road surveillance.

A detailed example of the road surveillance system 100 according to the example embodiment 1 will be described below.

### (Detail)

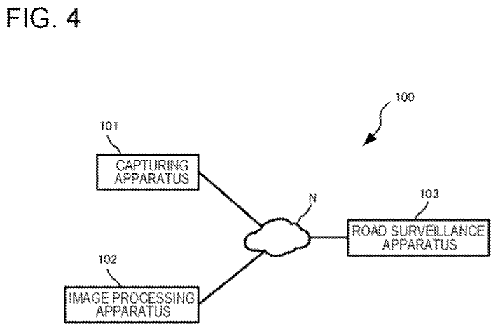

FIG. 4 is a diagram illustrating a configuration example of the road surveillance system 100 according to the example embodiment 1. The road surveillance system 100 is a system for detecting an object on a road by processing an image in which the road is captured, and assisting in surveillance of the road by a user, based on the detected result.

As illustrated in FIG. 4, the road surveillance system 100 includes a capturing apparatus 101, an image processing apparatus 102, and the road surveillance apparatus 103.

The capturing apparatus 101, the image processing apparatus 102, and the road surveillance apparatus 103 are connected to one another via a network N constituted in a wired manner, a wireless manner, or a combination of the manners, and can transmit and receive information to and from one another via the network N.

### (Functional Configuration Example of Capturing Apparatus 101)

The capturing apparatus 101 captures a predetermined place on a road, and generates an image. For example, the capturing apparatus 101 generates image information including the generated image, and transmits the image information to the image processing apparatus 102.

The capturing apparatus 101 performs capturing with a predetermined frequency (frame rate), for example. An image in this case is, for example, a frame image captured at a predetermined frame rate. Note that, an image may be either in color or monochrome, and a pixel number thereof may be appropriately selected.

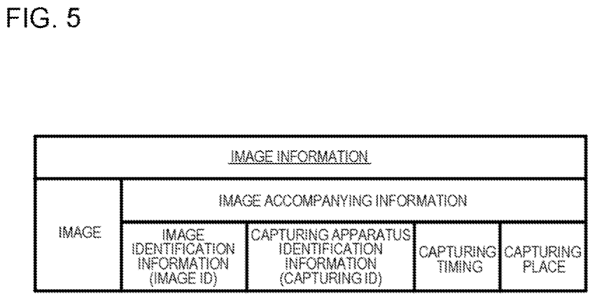

FIG. 5 is a diagram illustrating a configuration example of image information according to the example embodiment 1. The image information is information in which image accompanying information is associated with an image generated by the capturing apparatus 101. The image accompanying information is, for example, image identification information, capturing apparatus identification information, a capturing timing, a capturing place, and the like.

The image identification information is information for identifying the image information. Hereinafter, the image identification information is also referred to as an “image identification (ID)”.

The capturing apparatus identification information is information for identifying the capturing apparatus 101. Hereinafter, the capturing apparatus identification information is also referred to as a “capturing ID”.

The capturing timing is information indicating a timing at which capturing is performed. The capturing timing is formed of, for example, year, month, and day, and a time. The time may be represented by a predetermined interval such as a 1/10 second and a 1/100 second.

The capturing place is information indicating a place where capturing is performed. For example, the capturing place is information indicating a place where the capturing apparatus 101 is installed, and is formed of a latitude and a longitude indicating the place. When the capturing apparatus 101 has a position detection function, the capturing place may be acquired by using the position detection function, or may be preset by a person who installs the capturing apparatus 101, and the like. The position detection function is a function of detecting a position of the capturing apparatus 101 by using a global positioning system (GPS).

Note that, the capturing place is not limited to an installation place of the capturing apparatus 101, and may be, for example, information indicating a range in which the capturing apparatus 101 performs capturing, and, in this case, may be formed of a latitude and a longitude indicating the range. Further, the image information may include at least an image in which a road is captured, and may not include one or more pieces of other information.

### (Functional Configuration Example of Image Processing Apparatus 102)

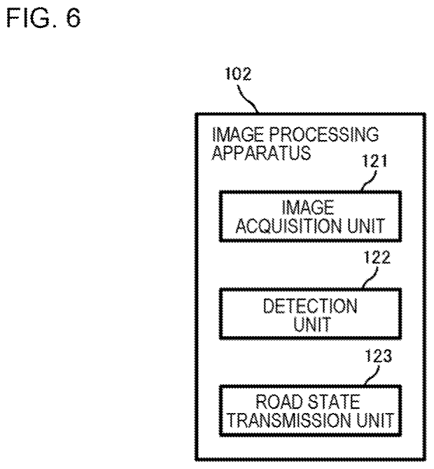

FIG. 6 is a diagram illustrating a functional configuration example of the image processing apparatus 102 according to the example embodiment 1. The image processing apparatus 102 is an apparatus that detects a road state by processing an image in which a road is captured. The image processing apparatus 102 includes an image acquisition unit 121, a detection unit 122, and a road state transmission unit 123.

The image acquisition unit 121 acquires image information from the capturing apparatus 101. In this way, the image acquisition unit 121 acquires at least an image generated by the capturing apparatus 101, i.e., an image in which a road is captured.

The detection unit 122 detects a road state by processing the image acquired by the image acquisition unit 121. The detection unit 122 generates state information including the detected road state.

The road state is a state of an object on a road.

An object on a road is, for example, one or a plurality of a vehicle, a fallen object, and the like. A vehicle is, for example, one or a plurality of a passenger car, a truck, a trailer, a construction vehicle, an emergency vehicle, a motorcycle, a bicycle, and the like. A fallen object is an object fallen from a vehicle and the like to a road, an object that comes flying on a road by wind and the like, and the like.

The road state includes presence or absence of an object on a road. When an object is present on a road, the road state includes object identification information and an object state of each object. Note that, presence or absence of an object on a road may be represented by a flag indicating the presence or absence, the number of objects on the road, and the like, or may be represented by whether the object identification information is included in the road state.

The object identification information is information for identifying an object on a road. Hereinafter, the object identification information is also referred to as an “object ID”.

The object state is a state of each object. A part or the whole of items included in the object state may be different for each kind of an object.

For example, the object state (a vehicle state) of a vehicle is one or a plurality of a position of the vehicle, a traveling direction of the vehicle, a velocity of the vehicle, a flow line (moved track) of the vehicle, an attribute of the vehicle, and the like. The attribute of the vehicle is, for example, one or a plurality of a kind of the vehicle, a size of the vehicle, a color of the vehicle, a vehicle number described on a number plate, and the like. The kind of the vehicle is, for example, one or a plurality of a passenger car, a truck, a trailer, a construction vehicle, an emergency vehicle, a motorcycle, a bicycle, and the like described above.

For example, the object state (a fallen object state) of a fallen object is one or a plurality of a position of the fallen object, a movement direction, a movement velocity, a flow line, an attribute of the fallen object, and the like. The attribute of the fallen object is, for example, one or a plurality of a kind of the fallen object, a size of the fallen object, a color of the fallen object, and the like. The kind of the fallen object is, for example, one or a plurality of wood, a packed object, and the like.

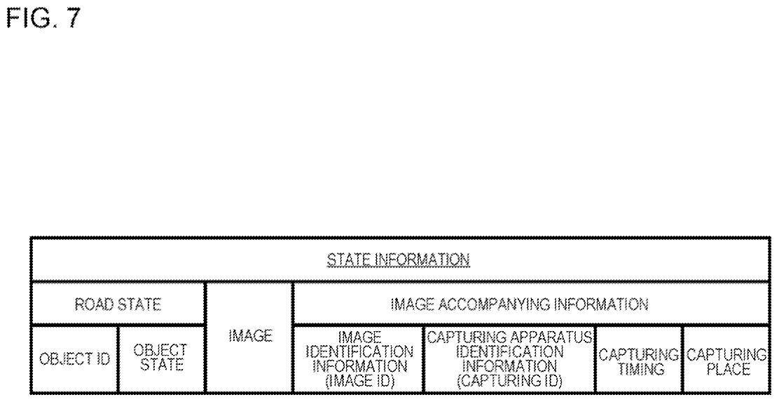

FIG. 7 is a diagram illustrating a configuration example of state information according to the example embodiment 1. The state information is information in which state accompanying information is associated with a road state. The state accompanying information includes an image used for detecting the associated road state, and image accompanying information associated with the image in image information.

Further, the state information may include at least a detected road state, and may not include one or more pieces of other information.

The road state transmission unit 123 transmits the generated state information to the image processing apparatus 102.

### (Functional Configuration Example of Road Surveillance Apparatus 103)

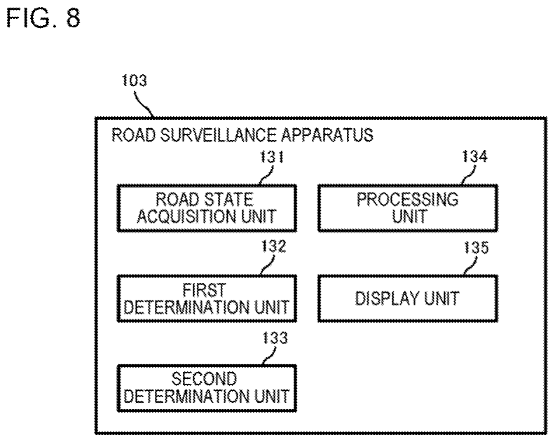

FIG. 8 is a diagram illustrating a functional configuration example of the road surveillance apparatus 103 according to the example embodiment 1. The road surveillance apparatus 103 is an apparatus for assisting in surveillance of a road by a user, based on a road state. The road surveillance apparatus 103 is installed at a surveillance center that monitors a road, and the like, for example.

As illustrated in FIG. 8, the road surveillance apparatus 103 includes the road state acquisition unit 131, a first determination unit 132, a second determination unit 133, the processing unit 134, and a display unit 135.

The road state acquisition unit 131 acquires state information from the image processing apparatus 102.

The first determination unit 132 determines whether a road state included in the state information satisfies a first criterion.

The first criterion is a criterion defined in relation to a road state. The first determination unit 132 detects a predetermined event on a road by determining whether the first criterion is satisfied. In other words, the event is a road state that satisfies the first criterion.

A kind of the event is, for example, one or a plurality of (1) congestion of vehicles, (2) reverse traveling of a vehicle, (3) low velocity traveling of a vehicle, (4) stop of a vehicle, (5) a fallen object, and (6) zigzag traveling. Note that, the event exemplified herein is an example of an abnormal event on a general road, which is not limited thereto.

The first criterion for each kind of the event is exemplified below. The first criterion is not limited to the following examples, and may be appropriately changed.

(1) The first criterion for the congestion is that, for example, a train of vehicles formed of vehicles that perform low velocity traveling or vehicles that repeat stop and start has a length equal to or more than a predetermined distance and continues for a predetermined time length or more. The low velocity traveling herein is traveling at a predetermined velocity or less.

(2) The first criterion for the reverse traveling of a vehicle is formed of, for example, (2-A) and (2-B) below. (2-A) is that a traveling direction is predetermined for a road being a target or each lane constituting the road. (2-B) is that a traveling direction of a vehicle and a traveling direction of a road or a lane on which the vehicle is traveling are different by over a predetermined angle (for example, 90 degrees).

When both of (2-A) and (2-B) are satisfied, the first determination unit 132 determines that the first criterion is satisfied (i.e., the reverse traveling of a vehicle occurs). When at least one of (2-A) and (2-B) is not satisfied, the first determination unit 132 determines that the first criterion is not satisfied.

(3) The first criterion for the low velocity traveling of a vehicle is that the vehicle is continuously traveling at a predetermined velocity or less for a predetermined time length or more, for example. The predetermined velocity herein may be the same as or different from a predetermined velocity defining low velocity traveling in (1) the congestion.

(4) The first criterion for the stop of a vehicle is that the vehicle is continuously stopping (a vehicle position falls within a predetermined range) for a predetermined time length or more, for example.

(5) The first criterion for the fallen object is, for example, that (5-A) an object other than a vehicle is present on a road. Further, for example, (5) the first criterion for the fallen object is that (5-B) a predetermined number or more of vehicles perform a temporary lane change in a common range.

The temporary lane change indicates that a vehicle changes a lane, and then returns to an original lane within a predetermined distance or a predetermined time. In general, a vehicle travels while avoiding a fallen object, and thus it is estimated that the fallen object is present in a range commonly avoided by a plurality of vehicles. Thus, a fallen object can be detected by using (5-B).

The first criterion for detecting a fallen object may use only one of (5-A) and (5-B), or may use both of (5-A) and (5-B). When both of (5-A) and (5-B) are used, for example, when both or any one of (5-A) and (5-B) is satisfied, the first determination unit 132 determines that the first criterion is satisfied (i.e., a fallen object is present). When both of (5-A) and (5-B) are not satisfied, the first determination unit 132 determines that the first criterion is not satisfied (i.e., a fallen object is not present).

(6) The first criterion for the zigzag traveling is that, for example, a vehicle repeats a temporary lane change for a predetermined number of times or more. As described above, the temporary lane change indicates that a vehicle changes a lane, and then returns to an original lane within a predetermined distance or a predetermined time.

FIG. 8 is referred.

The second determination unit 133 determines whether a determination result of the first determination unit 132, i.e., a determination result of whether a road state satisfies the first criterion satisfies a second criterion.

The second criterion is a criterion defined in relation to a determination result of the first determination unit 132 (i.e., a determination result of whether a road state satisfies the first criterion) in order to suppress a notification related to an event. The second criterion is, for example, a criterion defined in relation to the number of times or a frequency with which a road state is determined to satisfy the first criterion.

Specifically, for example, the second criterion is that a road state is determined to satisfy the first criterion with a frequency equal to or more than a predetermined value (i.e., the number of times equal to or more than a predetermined value within a predetermined period of time) or for the number of times equal to or more than a predetermined value. In other words, the second criterion is that an event is repeatedly detected with a frequency equal to or more than a predetermined value or for the number of times equal to or more than a predetermined value.

For example, when the first criterion is determined for each kind of an event as in the present example embodiment, a frequency or the number of times included in the second criterion may be calculated for each kind of an event defined by the first criterion. In other words, the second criterion is that an event of the same kind is repeatedly detected with a frequency equal to or more than a predetermined value or for the number of times equal to or more than a predetermined value.

For example, a frequency or the number of times included in the second criterion may be calculated for each specific event that satisfies the first criterion.

For a specific event, for example, a determination method may vary depending on a kind of the event. In a case of (1) congestion, a specific event may be determined by a region and a time period in which the congestion occurs, for example. In cases of (2) reverse traveling of a vehicle, (3) low velocity traveling, (4) stop, and (6) zigzag traveling, a specific event may be determined by an object ID of an associated vehicle, for example. In a case of (5) a fallen object, a specific event may be determined by at least one of an object ID of the fallen object, and a range and a time period in which a vehicle avoids.

Note that, when zigzag traveling is performed by a group (a plurality of vehicles), a specific event may be determined by a region and a time period in which the zigzag traveling occurs, for example The time period may include only a starting period, and may include an end period. The starting period is a period in which a specific event is first detected. The end period may be automatically set based on a history by the image processing apparatus 102 or the road surveillance apparatus 103, or may be set by a user.

FIG. 8 is referred.

The processing unit 134 performs processing, based on a determination result of the first determination unit 132 and the second determination unit 133. For example, when a road state satisfies the first criterion, the processing unit 134 performs any of the notification processing and the change-related processing, based on whether the second criterion is satisfied.

The notification processing is processing of making a notification of an event (i.e., a road state that satisfies the first criterion). For example, the notification processing is processing for notifying a user of an event. The notification processing is performed according to notification setting. The notification setting is setting related to a notification of an event. Details of the notification setting will be described below.

The change-related processing is processing related to a change in the notification setting. The change-related processing includes, for example, first confirmation processing for making a confirmation related to a change in the notification setting from a user, change processing of changing the notification setting, and the like.

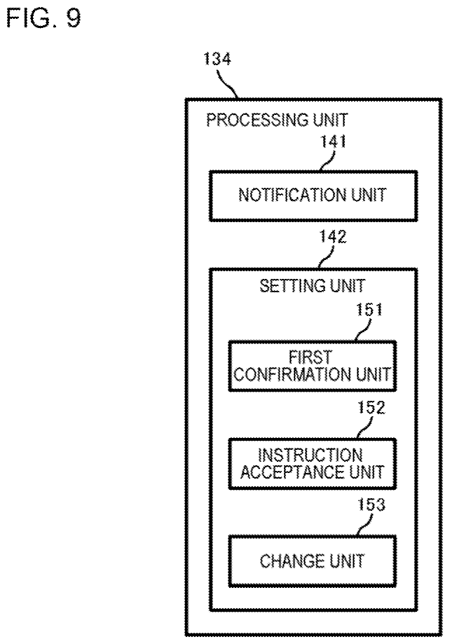

FIG. 9 is a diagram illustrating a functional configuration example of the processing unit 134 according to the example embodiment 1. The processing unit 134 includes a notification unit 141 and a setting unit 142.

The notification unit 141 holds notification setting in advance, and performs the notification processing according to the notification setting. For example, the notification unit 141 performs the notification processing when the first criterion is satisfied and the second criterion is not satisfied. Note that, the notification unit 141 may perform the notification processing when the first criterion is satisfied regardless of whether the second criterion is satisfied.

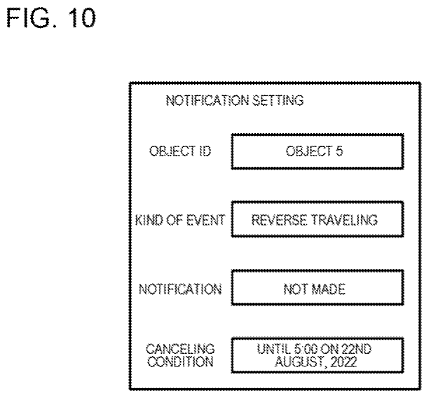

FIG. 10 is a diagram illustrating one example of the notification setting according to the example embodiment 1. Note that, the notification setting is not limited to that illustrated in FIG. 10, and may be appropriately changed by deleting or adding an item, and the like.

The notification setting includes, for example, setting related to whether to make a notification of an event. The notification setting may be set for a specific event, may be set for a kind of an event, or may be set for a specific object. The notification setting may include a canceling condition of a setting content. The canceling condition may include a range in terms of a place, and a time period including at least one of a starting period and an end period.

The notification setting illustrated in FIG. 10 includes setting that a notification of an event “reverse traveling” being a road state that satisfies the first criterion is “not made” for a vehicle having an object ID of “object 5”. The notification setting is a setting example of a specific event.

The notification setting illustrated in FIG. 10 includes a canceling condition of “until 5:00 on 22nd August, 2022”. In other words, the notification setting that a notification is “not made” for “reverse traveling” of a vehicle having an object ID of “object 5” is applied to the notification processing until “5:00 on 22nd August, 2022”, and is not applied to the notification processing after 5:00 on 22nd August, 2022.

Note that, when setting is performed for a kind of an event, for example, an object ID may not be set in the notification setting illustrated in FIG. 10. Such notification setting may be applied to an event of a set kind regardless of an object related to the event. Specifically, when setting is performed for “congestion”, an example of the notification setting not including an object ID and including “congestion” as a kind of an event can be used. In this case, the notification setting may include a region and a time period of the congestion in order to determine the congestion.

Further, for example, when setting is performed for a specific object, a kind of an event may not be set in the notification setting illustrated in FIG. 10. Such notification setting may be applied to events of all kinds related to an object determined by an object ID. Specifically, when setting is performed for a fallen object, an example of the notification setting including an object ID of the fallen object and not including a kind of an event can be used.

FIG. 9 is referred.

The setting unit 142 performs the change-related processing. For example, the setting unit 142 performs the change-related processing when the first criterion is satisfied and the second criterion is satisfied.

As illustrated in FIG. 9, the setting unit 142 includes a first confirmation unit 151, an instruction acceptance unit 152, and a change unit 153.

The first confirmation unit 151 performs first confirmation processing. For example, the first confirmation unit 151 displays a first confirmation screen on the display unit 135 as the first confirmation processing. The first confirmation screen is a screen for making a confirmation of a change in the notification setting from a user.

The instruction acceptance unit 152 accepts an instruction by a user (i.e., a user instruction). For example, the instruction acceptance unit 152 accepts a user instruction as a response to the confirmation processing (for example, the first confirmation screen displayed on the display unit 135).

The user instruction includes, for example, an instruction to change the notification setting. The instruction to change the notification setting may include a content of the notification setting after the change. The user instruction may include an instruction not to change the notification setting.

The setting unit 153 performs change processing. The change processing is processing of changing the notification setting according to a user instruction for the confirmation processing.

Specifically, when the instruction acceptance unit 152 accepts an instruction to change the notification setting for the confirmation processing, the change unit 153 changes the notification setting according to the user instruction. As described above, the user instruction in this case includes a content of the notification setting after the change, and thus the change unit 153 may cause the notification unit 141 to hold a content of the notification setting included in the user instruction.

When the instruction acceptance unit 152 accepts an instruction not to change the notification setting for the confirmation processing, the change unit 153 does not change the notification setting according to the user instruction. As a result, the notification unit 141 continues to hold the notification setting being held.

FIG. 8 is referred.

The display unit 135 displays various types of information. In this way, a user can view the various types of information.

The functional configuration example of the road surveillance system 100 according to the example embodiment 1 is mainly described above. Hereinafter, a physical configuration example of the road surveillance system 100 according to the example embodiment 1 will be described.

### (Physical Configuration Example of Road Surveillance System 100)

The road surveillance system 100 physically includes, for example, the capturing apparatus 101, the image processing apparatus 102, and the road surveillance apparatus 103.

Note that, the image processing apparatus 102 may physically include the capturing apparatus 101, and the road surveillance apparatus 103 may physically include one or both of the capturing apparatus 101 and the image processing apparatus 102. When a function of transmitting or receiving information among the apparatuses 101 to 103 via the network N is physically incorporated into a common apparatus, the information may be transmitted or received via an internal bus and the like instead of the network N.

### (Physical Configuration Example of Capturing Apparatus 101)

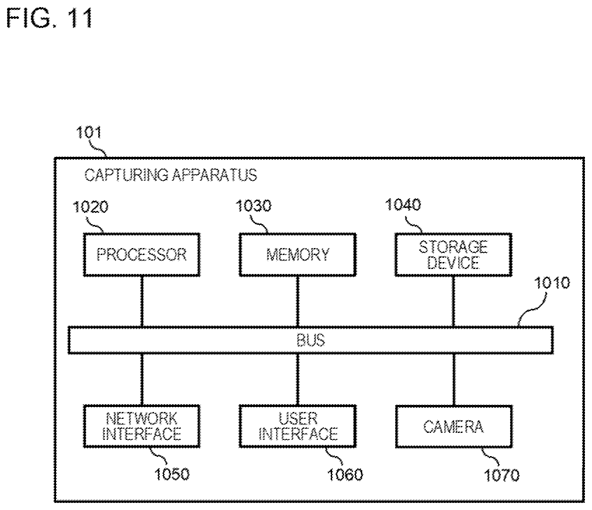

FIG. 11 is a diagram illustrating a physical configuration example of the capturing apparatus 101 according to the example embodiment 1. The capturing apparatus 101 physically includes, for example, a bus 1010, a processor 1020, a memory 1030, a storage device 1040, a network interface 1050, a user interface 1060, and a camera 1070.

The bus 1010 is a data transmission path for allowing the processor 1020, the memory 1030, the storage device 1040, the network interface 1050, the user interface 1060, and the camera 1070 to transmit and receive data with one another. However, a method for connecting the processor 1020 and the like to one another is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function of the capturing apparatus 101. The processor 1020 reads each program module onto the memory 1030 and executes the program module, and each function associated with the program module is achieved.

The network interface 1050 is an interface for connecting the capturing apparatus 101 to the network N.

The user interface 1060 is a touch panel, a keyboard, a mouse, and the like as an interface for inputting information by a user, and a liquid crystal panel, an organic electro-luminescence (EL) panel, and the like as an interface for providing information to a user.

The camera 1070 captures a subject such as a road, and generates an image of the subject. For example, the capturing apparatus 101 is fixed beside a road, above a road, and the like in such a way that the camera 1070 can capture a predetermined place on the road.

Note that, the capturing apparatus 101 may accept an input from a user or may provide information to a user via an external apparatus (for example, the image processing apparatus 102, the road surveillance apparatus 103, and the like) connected to the network N. In this case, the capturing apparatus 101 may not include the user interface 1060.

### (Physical Configuration Example of Image Processing Apparatus 102 and Road Surveillance Apparatus 103)

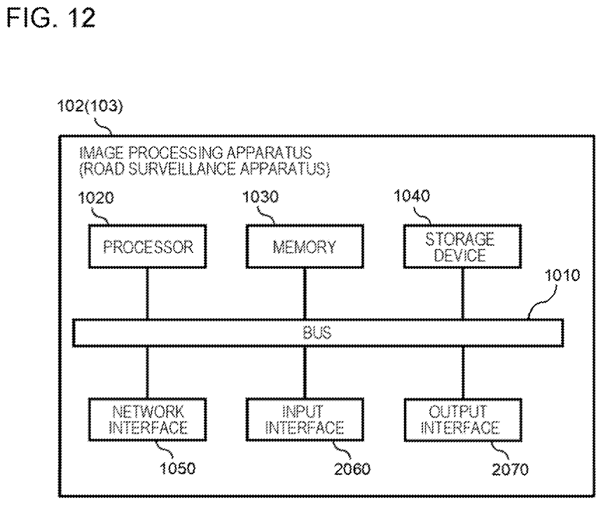

FIG. 12 is a diagram illustrating a physical configuration example of the image processing apparatus 102 according to the example embodiment 1. The image processing apparatus 102 physically includes, for example, the bus 1010, the processor 1020, the memory 1030, the storage device 1040, and the network interface 1050 similar to those of the capturing apparatus 101. The image processing apparatus 102 further physically includes, for example, an input interface 2060 and an output interface 2070.

However, the storage device 1040 of the image processing apparatus 102 stores a program module for achieving each function of the image processing apparatus 102. Further, the network interface 1050 of the image processing apparatus 102 is an interface for connecting the image processing apparatus 102 to the network N.

The input interface 2060 is an interface for a user to input information, and includes, for example, a touch panel, a keyboard, a mouse, and the like. The output interface 2070 is an interface for providing information to a user, and includes, for example, a liquid crystal panel, an organic EL panel, and the like.

The road surveillance apparatus 103 according to the example embodiment 1 may be physically configured similarly to the image processing apparatus 102, for example. However, the storage device 1040 of the road surveillance apparatus 103 stores a program module for achieving each function of the road surveillance apparatus 103. Further, the network interface 1050 of the road surveillance apparatus 103 is an interface for connecting the road surveillance apparatus 103 to the network N.

The configuration example of the road surveillance system 100 according to the example embodiment 1 is described above. Hereinafter, an operation example of the road surveillance system 100 according to the example embodiment 1 will be described.

### (Operation Example of Road Surveillance System 100)

The road surveillance system 100 performs road surveillance processing for surveying a road. The road surveillance processing includes, for example, capturing processing performed by the capturing apparatus 101, image processing performed by the image processing apparatus 102, and surveillance processing performed by the road surveillance apparatus 103. The processing will be described with reference to the drawing.

### (Example of Capturing Processing According to Example Embodiment 1)

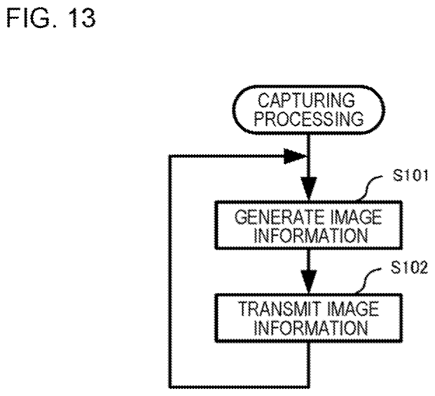

FIG. 13 is a flowchart illustrating one example of the capturing processing according to the example embodiment 1. The capturing processing is processing for capturing a road. For example, when the capturing apparatus 101 accepts a start instruction by a user via the road surveillance apparatus 103, the capturing apparatus 101 repeatedly performs the capturing processing until an end instruction by a user is accepted. Note that, a method for starting or ending the capturing processing is not limited thereto.

The capturing apparatus 101 captures a road, and generates image information (step S101).

Specifically, for example, when the camera 1070 captures a predetermined place on a road, the capturing apparatus 101 generates image information including an image acquired by the capturing.

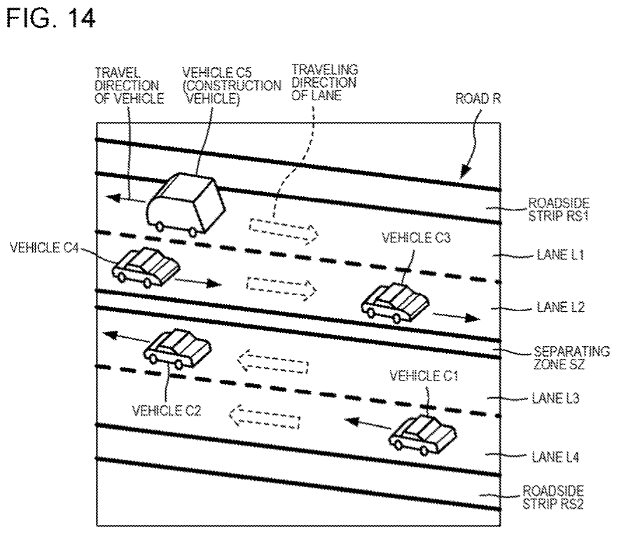

FIG. 14 is a diagram illustrating one example of a road R to be captured.

The road R includes roadside strips RS1 and RS2 provided along both sides of the road R, and a separating zone SZ provided at substantially the center along the road. The road R further includes lanes L1 and L2 provided between the roadside strip RS1 and the separating zone SZ, and lanes L3 and L4 provided between the roadside strip RS2 and the separating zone SZ.

An arrow represented by a dotted line in FIG. 14 indicates a traveling direction determined in each of the lanes. In other words, the traveling direction in the lanes L1 and L2 is a lower right direction in FIG. 14. The traveling direction in the lanes L3 and L4 is an upper left direction in FIG. 14.

Vehicles C1, C2, C3, C4, and C5 are traveling on the road R. The vehicles C1, C2, C3, and C4 are passenger cars, and the vehicle C5 is a construction vehicle.

An arrow of a solid line in FIG. 14 indicates a traveling direction of a vehicle. In other words, the vehicles C1 and C2 are traveling according to the traveling direction in the lanes L3 and L4 in which the vehicles C1 and C2 are traveling. The vehicles C3 and C4 are traveling according to the traveling direction in the lane L2 in which the vehicles C3 and C4 are traveling. The vehicle C5 is traveling in a direction opposite (i.e., reverse traveling) to the traveling direction in the lane L1 in which the vehicle C5 is traveling.

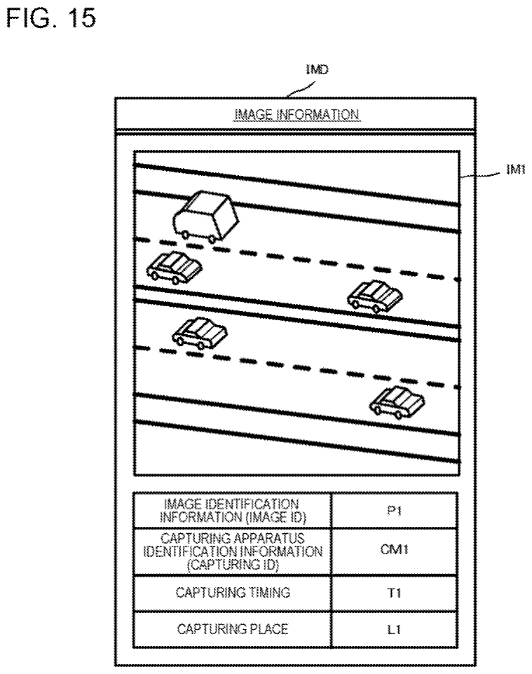

FIG. 15 is a diagram illustrating one example of image information IMD including an image IM1 in which the road R illustrated in FIG. 14 is captured. The image information IMD illustrated in FIG. 15 associates image accompanying information with the image IM1. The image accompanying information illustrated in FIG. 15 associates an image ID “P1”, a capturing ID “CM1”, a capturing timing “T1”, and a capturing place “L1” with one another.

“P1” is an image ID provided to the image IM1. For example, the capturing apparatus 101 may provide the image ID of the image IM according to a predetermined rule, and may set the image ID to the image information IMD. “CM1” is a capturing ID of the capturing apparatus 101. For example, the capturing apparatus 101 may hold a capturing ID preset by a user via the road surveillance apparatus 103, and may set the capturing ID to the image information IMD.

“T1” indicates a timing at which the image IM1 is captured. The capturing apparatus 101 has, for example, a timer function, and may set a time during capturing as a capturing timing to the image information IMD.

“L1” is information indicating a place captured by the capturing apparatus 101. For example, the capturing apparatus 101 may hold, in advance, a capturing place (for example, an installation place of the capturing apparatus 101) preset by a user via the road surveillance apparatus 103, and may set the capturing place to the image information IMD.

FIG. 13 is referred again.

The capturing apparatus 101 transmits the image information generated in step S101 to the image processing apparatus 102 (step S102), and the processing returns to step S101.

The capturing apparatus 101 performs such capturing processing, and thus each frame image captured at a predetermined frame rate can be transmitted to the image processing apparatus 102 in substantially real time. Note that, transmission of image information about a part of a captured frame image may be performed at a preset time interval.

### (Example of Image Processing According to Example Embodiment 1)

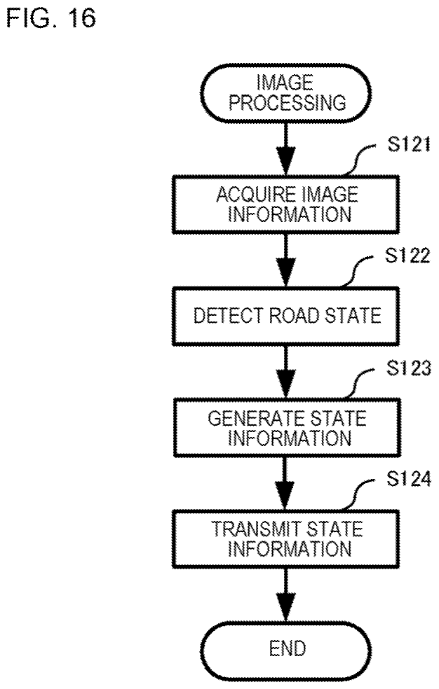

FIG. 16 is a flowchart illustrating one example of image processing according to the example embodiment 1. The image processing is processing for detecting a road state by processing an image in which a road is captured. For example, similarly to the capturing apparatus 101, when the image processing apparatus 102 accepts a start instruction by a user via the road surveillance apparatus 103, the image processing apparatus 102 repeatedly performs the image processing until an end instruction by a user is accepted. Note that, a method for starting or ending the image processing is not limited thereto.

The image acquisition unit 121 acquires the image information transmitted in step S102 (step S121).

The detection unit 122 detects a road state by processing the image acquired in step S121 (step S122).

Specifically, for example, the detection unit 122 processes the image according to preset image processing setting. The image processing setting includes, for example, at least one of setting indicating a position of a road or a lane in an image, setting indicating an actual distance between reference points in an image, setting indicating a road or a traveling direction determined in each lane on a road, and the like. The position of a road or a lane may be set by using, for example, a position of both ends (for example, a white line) of the road or the lane.

For example, the detection unit 122 detects a road and an object on the road by processing the image, and provides object identification information to each detected object. The object identification information may be provided according to a predetermined rule.

The detection unit 122 detects a road state for the detected object.

A general technique such as pattern matching and a learned learning model subjected to machine learning may be used for a technique for detecting a road state.

When the learning model is used, the detection unit 122 detects a road state by, for example, inputting an image acquired by the image acquisition unit 121 to the learned learning model subjected to the machine learning for detecting a road state. In the machine learning, for example, training leaning using, as input data, training data providing a label to an image in which a road is captured may be performed.

Of a road state, for example, a position and an attribute of a vehicle or a fallen object may be detected from an image (latest image) acquired in the latest step S121. Further, for example, a traveling direction, a velocity, and a flow line of a vehicle may be detected by using the latest image, and an image (past image) acquired in the past from the capturing apparatus 101. Specifically, for example, a traveling direction, a velocity, and a flow line of a vehicle may be detected by using a position of the vehicle detected from the latest image and a position of the same vehicle detected from the past image. Similarly, a movement direction, a movement velocity, and a flow line of a fallen object may also be detected by using the latest image and the past image.

Further, a position of an object may be a position in an image. The position in the image is represented by using, for example, a position of a pixel in a region occupied by the object in the image, but a method for representing a position in an image is not limited thereto. Note that, a position of an object is not limited to a position in an image, and may be a position in a real space, and the like, for example. The position in the real space is represented by using, for example, a latitude and a longitude, but a method for representing a position in a real space is not limited thereto.

The detection unit 122 generates state information including the road state detected in step S122 (step S123).

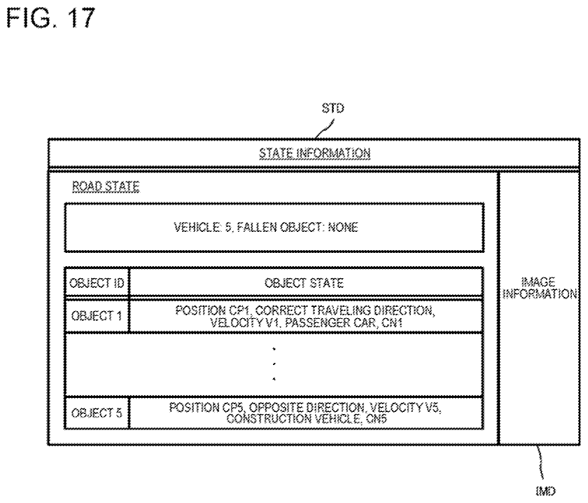

FIG. 17 is a diagram illustrating one example of state information STD generated in step S123. The state information STD is an example of state information generated based on the image information IMD illustrated in FIG. 15.

The state information STD includes a road state detected based on the image IM1.

Specifically, the road state included in the state information STD indicates that there are five vehicles and no fallen object on the road R. The road state further associates an object ID and an object state with each object on the road.

“Object 1” and “object 5” illustrated in FIG. 17 are object IDs of the vehicle C1 and the vehicle C5, respectively.

An object state associated with “object 1” includes “position CP1, correct traveling direction, velocity V1, passenger car, CN1”. An object state associated with “object 5” includes “position CP5, opposite direction, velocity V5, construction vehicle, CN5”.

“Position CP1” and “position CP5” are examples of information indicating positions of the associated vehicles C1 and C5, respectively. “Correct traveling direction” and “opposite direction” are examples of information indicating traveling directions of the associated vehicles C1 and C5, respectively. A traveling direction of a vehicle in this example indicates whether the traveling direction is a correct traveling direction according to a traveling direction on a road or in a lane.

“Velocity V1” and “velocity V5” are examples of information indicating velocities of the associated vehicles C1 and C5, respectively.

“Passenger car” and “construction vehicle” are examples of information indicating kinds of the associated vehicles C1 and C5, respectively. “CN1” and “CN5” are examples of information indicating vehicle numbers of the associated vehicles C1 and C5, respectively. In other words, the state information STD is an example in which a kind of a vehicle and a vehicle number are included in an attribute of the vehicle.

Further, in the state information STD, the image information IMD acquired in step S121 is associated with the road state detected in step S122. As described above, the image information IMD includes the image IM1. Such an image IM1 is an example of a latest image.

FIG. 16 is referred again.

The road state transmission unit 123 transmits the state information generated in step S123 to the road surveillance apparatus 103 (step S124).

As described above, in the present example embodiment, the capturing apparatus 101 transmits image information including a captured image in substantially real time. Then, when the image processing apparatus 102 acquires the image information (step S121), the image processing apparatus 102 performs steps S122 to S124. Therefore, the image processing apparatus 102 can detect a road state in substantially real time, and transmit state information including the road state to the road surveillance apparatus 103.

### (Example of Surveillance Processing According to Example Embodiment 1)

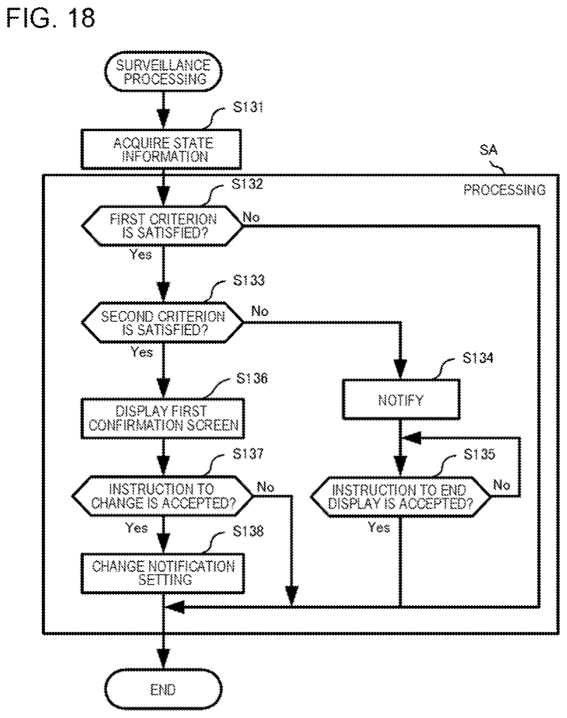

FIG. 18 is a flowchart illustrating one example of surveillance processing according to the example embodiment 1. The surveillance processing is processing for assisting in surveillance of a road by a user, based on a road state.

For example, when the road surveillance apparatus 103 accepts a start instruction by a user, the road surveillance apparatus 103 transmits the start instruction to the capturing apparatus 101 and the image processing apparatus 102, and also starts the surveillance processing. Then, for example, when the road surveillance apparatus 103 accepts an end instruction by a user, the road surveillance apparatus 103 transmits the end instruction to the capturing apparatus 101 and the image processing apparatus 102, and also ends the surveillance processing. In other words, for example, when the road surveillance apparatus 103 accepts a start instruction by a user, the road surveillance apparatus 103 repeatedly performs the surveillance processing until an end instruction by a user is accepted. Note that, a method for starting or ending the surveillance processing is not limited thereto.

The road state acquisition unit 131 acquires the state information transmitted in step S124 (step S131).

In addition to the processing unit 134, the first determination unit 132 and the second determination unit 133 perform processing (step SA).

In the processing (step SA), the first determination unit 132 determines whether the road state included in the state information acquired in step S131 satisfies the first criterion (step S132). In this way, the first determination unit 132 detects occurrence of a predetermined event from the road state.

Specifically, for example, in the road state included in the state information STD (see FIG. 17), the vehicle C being “object 5” is reverse traveling. Thus, when the state information STD is acquired in step S131, the first determination unit 132 determines that a state of the vehicle C5 being “object 5” satisfies the first criterion. In this way, the first determination unit 132 detects occurrence of a specific event of “reverse traveling” for the vehicle C5 being “object 5”. Hereinafter, the specific event (i.e., “reverse traveling” of the vehicle C5 being “object 5”) is also referred to as “event 1”.

When it is determined that the first criterion is not satisfied (step S132; No), the first determination unit 132 ends the surveillance processing.

When it is determined that the first criterion is satisfied (step S132; Yes), the second determination unit 133 determines whether the second criterion is satisfied, based on the determination result in step S132 (step S133).

Specifically, for example, the second determination unit 133 determines whether the second criterion is satisfied, based on a history of the determination result. Herein, the second criterion is assumed that a specific event occurs with a predetermined frequency or more (for example, a predetermined number of times or more within a predetermined period of time). In this case, the second determination unit 133 refers to the past determination result in step S132, and determines whether it is determined that the event 1 occurs with a predetermined frequency or more.

When it is determined that the second criterion is not satisfied (step S133; No), the notification unit 141 performs the notification processing according to notification setting (step S134).

Specifically, for example, when the notification setting indicates that a notification of the event 1 detected in step S132 is prohibited, the notification unit 141 does not make the notification of the event 1 in step S134. When the notification setting does not indicate that the notification of the event 1 is prohibited, the notification unit 141 makes the notification of the event 1. For example, the notification unit 141 makes a notification by displaying a notification screen including information about the event 1 on the display unit 135. Note that, a method for making a notification of an event is not limited to display on a screen, and may be appropriately changed.

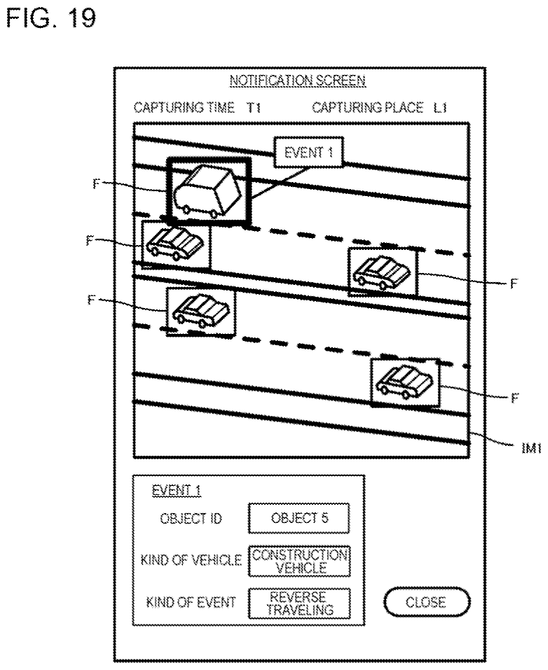

FIG. 19 is a diagram illustrating one example of a notification screen according to the example embodiment 1. The notification screen illustrated in FIG. 19 is an example of a screen for making a notification of the event 1. Note that, the notification screen is not limited thereto, and, for example, information and the like included in the notification screen may be appropriately changed.

The notification screen illustrated in FIG. 19 includes the image IM1 indicating a road state in which the event 1 is detected, and a capturing timing and a capturing place of the image IM1. The capturing timing and the capturing place included in the notification screen are examples of information indicating a timing and a place at which the event 1 is detected, respectively.

Further, the notification screen illustrated in FIG. 19 includes a frame F being an indicator for identifying each object included in the image. The frame F is indicated over the image IM1 in such a way as to surround each of the vehicles C1 to C5 being an object included in the image IM1.

The frame F surrounding the vehicle C5 being an object related to the event 1 is indicated in a manner different from the frame F surrounding the other vehicles C1 to C4. FIG. 19 illustrates an example in which the frame F surrounding the vehicle C5 is a line thicker than the frame F surrounding the other vehicles C1 to C4, but a different manner for the frame F is not limited thereto. A label indicating information “event 1” for identifying a detected event is associated with the frame F surrounding the vehicle C5.

Furthermore, the notification screen illustrated in FIG. 19 includes the information about the event 1 under the image IM1. The information about the event 1 includes an object ID of an object related to the event 1, an object state of the object, and a kind of the event. FIG. 19 illustrates an example in which an object state included in the notification screen is a kind of a vehicle being one attribute of the vehicle.

Note that, the notification screen is not limited thereto, and may include one or a plurality of appropriate road states. For example, an object state included in the notification screen is not limited to a kind of a vehicle, and may be one or a plurality of other object states, or may be one or a plurality of pieces of object information.

Further, when a predetermined display condition related to a display item is satisfied, such as a “kind of a vehicle is a construction vehicle”, for example, the notification screen may include the display item.

FIG. 18 is referred again.

The notification unit 141 determines whether a display end instruction of the notification screen is accepted (step S135). When it is determined that the display end instruction is not accepted (step S135: No), the notification unit 141 waits until the display end instruction is accepted. When it is determined that the display end instruction is accepted (step S135: Yes), the notification unit 141 closes the notification screen, and ends the surveillance processing.

In this way, the notification unit 141 can continue to display the notification screen on the display unit 135 until the display end instruction is accepted. In the example of the notification screen in FIG. 19, the display end instruction may be accepted by pressing a “close” button. In this case, the notification unit 141 can continue to display the notification screen on the display unit 135 until the “close” button is pressed.

FIG. 18 is referred again.

When it is determined that the second criterion is satisfied (step S133: Yes), the first confirmation unit 151 displays a first confirmation screen on the display unit 135 (step S136).

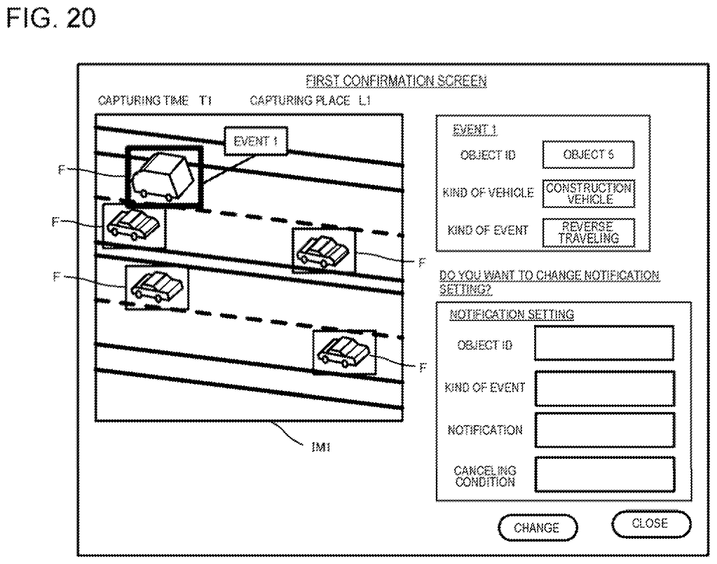

FIG. 20 is a diagram illustrating one example of the first confirmation screen according to the example embodiment 1. The first confirmation screen illustrated in FIG. 20 is an example of a screen for making a confirmation of a change in the notification setting related to the event 1 from a user.

The first confirmation screen includes information similar to that in the notification screen illustrated in FIG. 19. In other words, the first confirmation screen includes the image IM1 associated with the event 1 (i.e., a road state determined to satisfy the first criterion), and the frame F being an indicator for identifying each object included in the image IM1. Further, the first confirmation screen further includes an attribute (“construction vehicle” in the example in FIG. 20) of the vehicle C5 related to the event 1.

The first confirmation screen further includes information for confirming a change in the notification setting. The information includes a message that “do you want to change notification setting?” in the example illustrated in FIG. 20. Further, the information includes an object ID, a kind of an event, a notification manner, and a canceling condition as items of the notification setting related to the event 1 in the example illustrated in FIG. 20. In the example in FIG. 20, the notification manner is an item for setting whether to make a notification.

Note that, the first confirmation screen is not limited thereto, and may be appropriately changed. For example, the notification manner is not limited to indicating whether to make a notification, and a notification frequency with which a notification is made at a specified time interval may be set.

FIG. 18 is referred again.

The change unit 153 determines whether the instruction acceptance unit 152 has accepted an instruction to change (step S137).

In the example of the first confirmation screen illustrated in FIG. 20, the change unit 153 determines that the instruction to change the notification setting is accepted when information is input (instructed) to an item of the notification setting, and a “change” button is then pressed. The instruction includes the information input to the item of the notification setting. Note that, the change unit 153 may accept an instruction to change on a condition that at least a predetermined necessary item (for example, at least one of an object ID and a kind of an event, and whether to make a notification) is input.

Further, in the example of the first confirmation screen illustrated in FIG. 20, the change unit 153 determines that the instruction to change the notification setting is not accepted when the “close” button is pressed.

FIG. 18 is referred again.

When it is determined that the instruction to change is not accepted (step S137: No), the change unit 153 closes the first confirmation screen, and ends the surveillance processing.

When it is determined that the instruction to change is accepted (step S137: Yes), the change unit 153 changes the notification setting according to a content of the notification setting after a change included in the instruction (step S138), and ends the surveillance processing.

In the example of the first confirmation screen illustrated in FIG. 20, it is assumed that “object 5” is input to an object ID, “reverse traveling” is input to a kind of an event, “not made” is input to whether to make a notification, “until 5:00 on 22nd August, 2022” is input to a canceling condition, and the “change” button is pressed. In this case, the change unit 153 causes the notification unit 141 to hold the notification setting illustrated in FIG. 10. In this way, the notification setting is changed to the content illustrated in FIG. 10.

As described above, the notification unit 141 makes a notification according to the notification setting in step S134. Thus, when the notification setting illustrated in FIG. 10 is held, the notification unit 141 does not make a notification related to the event 1 “until 5:00 on 22nd August, 2022”.

When there is an event detected for a predetermined number of times or more or with a predetermined frequency or more, such surveillance processing can suppress a notification related to the event in response to an instruction of a user. In this way, time and effort to repeatedly confirm a known event can be reduced. Therefore, efficiency of road surveillance can be improved.

### (Action and Effect)

As described above, according to the example embodiment 1, the road surveillance system includes the detection unit 122 and the processing unit 134.

The detection unit 122 detects a road state being a state of an object on a road by processing an image in which the road is captured. The processing unit 134 performs, when the road state satisfies a first criterion, any of notification processing of making a notification of the road state that satisfies the first criterion according to notification setting related to the notification, and change-related processing related to a change in the notification setting, based on whether a second criterion related to a determination result of whether the road state satisfies the first criterion is satisfied.

In this way, a change in the notification setting can be confirmed with a user, based on the second criterion. Thus, the user can change the notification setting at an appropriate timing. Therefore, efficiency of road surveillance can be improved.

According to the example embodiment 1, the processing unit 134 includes the notification unit 141 and the setting unit 142. The notification unit 141 performs the notification processing when the first criterion is satisfied. The setting unit 142 performs the change-related processing when the first criterion is satisfied and the second criterion is satisfied.

In this way, a change in the notification setting can be confirmed with a user, based on the second criterion. Thus, the user can change the notification setting at an appropriate timing. Therefore, efficiency of road surveillance can be improved.

According to the example embodiment 1, the notification unit 141 performs the notification processing when the first criterion is satisfied and the second criterion is not satisfied.

In this way, a notification needed for surveying a road can be reliably made. Therefore, efficiency of road surveillance can be improved.

According to the example embodiment 1, the change-related processing includes the first confirmation processing of displaying, on the display unit 135, the first confirmation screen for making a confirmation related to a change in the notification setting from a user.

In this way, the user can easily recognize an advantage of making a confirmation related to a change in the notification setting by viewing the first confirmation screen. Therefore, efficiency of road surveillance can be improved.

According to the example embodiment 1, the first confirmation screen includes an image associated with a road state determined to satisfy the first criterion, and an indicator for identifying each object included in the image.

In this way, the user can easily recognize an object in the image associated with the road state determined to satisfy the first criterion, and can thus easily make a confirmation related to a change in the notification setting. Therefore, efficiency of road surveillance can be improved.

According to the example embodiment 1, an object includes a vehicle. A road state includes an attribute of the vehicle. The first confirmation screen further includes an attribute of the vehicle.

In this way, a user can easily identify a vehicle together with an attribute of the vehicle in an image associated with a road state determined to satisfy the first criterion, and can thus easily make a confirmation related to a change in the notification setting when the notification setting is performed in response to the attribute of the vehicle. Therefore, efficiency of road surveillance can be improved.

According to the example embodiment 1, the first criterion is a criterion defined in relation to a road state. The notification setting includes setting related to whether to make a notification of the road state that satisfies the first criterion. The change-related processing includes the change processing of changing the notification setting according to a user instruction for the confirmation processing.

In this way, a user can change the notification setting related to an event on a road in response to the first criterion at an appropriate timing Therefore, efficiency of road surveillance can be improved.

According to the example embodiment 1, the notification setting includes a canceling condition of a setting content.

In this way, a condition can be provided for the notification setting, and a notification needed for surveying a road can be reliably made. Therefore, efficiency of road surveillance can be improved.

According to the example embodiment 1, the second criterion includes a criterion defined in relation to the number of times or a frequency with which a road state is determined to satisfy the first criterion.

In this way, a change in the notification setting can be confirmed with a user in response to the number of times or a frequency with which a road state is determined to satisfy the first criterion. Thus, the user can change the notification setting at an appropriate timing. Therefore, efficiency of road surveillance can be improved.

### Example Embodiment 2

In the present example embodiment, an example in which a road surveillance apparatus automatically changes notification setting regardless of an instruction by a user will be described.

In the present example embodiment, description of a configuration similar to that in the example embodiment 1 will be appropriately omitted for simplifying the description.

A road surveillance system according to an example embodiment 2 includes the road surveillance apparatus including a processing unit 234 instead of the processing unit 134 according to the example embodiment 1.

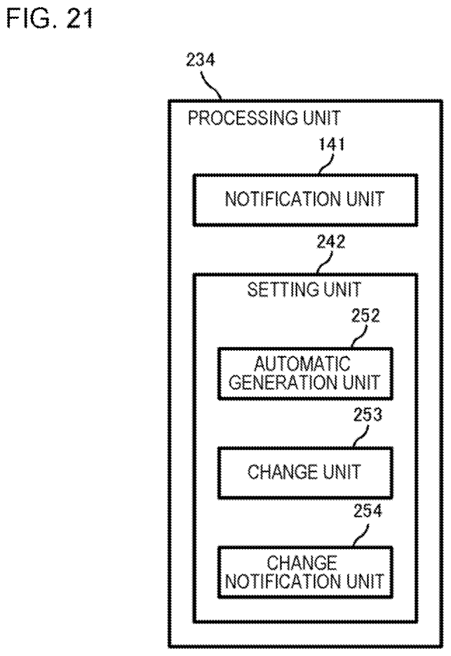

FIG. 21 is a diagram illustrating a functional configuration example of the processing unit 234 according to the example embodiment 2. Similarly to the example embodiment 1, the processing unit 234 performs processing, based on a determination result of a first determination unit 132 and a second determination unit 133. For example, when a road state satisfies a first criterion, the processing unit 234 performs any of notification processing and change-related processing, based on whether a second criterion is satisfied.

The change-related processing according to the present example embodiment includes, for example, automatic generation processing and change processing. The automatic generation processing is processing of generating a change value for changing notification setting in such a way as to suppress a notification of an event (i.e., a notification of a road state that satisfies the first criterion). The change processing changes the notification setting by using the change value generated by the automatic generation processing.

The change-related processing according to the present example embodiment may further include, for example, change notification processing. The change notification processing is processing of notifying a user that the notification setting is changed based on the change value. Note that, the notification processing may be similar to that in the example embodiment 1.

As illustrated in FIG. 21, the processing unit 234 includes a notification unit 141 similar to that in the example embodiment 1, and a setting unit 242 instead of the setting unit 142 according to the example embodiment 1.

The setting unit 242 performs the change-related processing according to the present example embodiment. For example, the setting unit 242 performs the change-related processing according to the present example embodiment when the first criterion is satisfied and the second criterion is satisfied.

As illustrated in FIG. 21, the setting unit 242 includes an automatic generation unit 252, a change unit 253, and a change notification unit 254.

The automatic generation unit 252 performs the automatic generation processing. The automatic generation unit 252 holds a notification change rule being preset by a user or the like, and generates a change value according to the notification change rule.

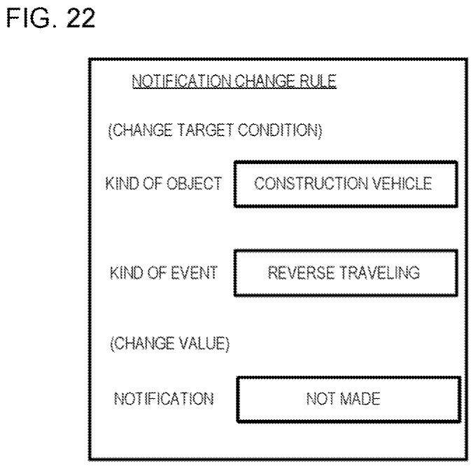

FIG. 22 is a diagram illustrating one example of the notification change rule according to the example embodiment 2. The notification change rule includes a change target condition and a change value.

The change target condition includes a condition for determining an event being a target of a change in notification setting. The notification change rule illustrated in FIG. 22 includes a change target condition in which “reverse traveling” of “construction vehicle” is determined as an event being a target of a change.

For the change value, a change value for an event that satisfies the change target condition is determined. The notification change rule illustrated in FIG. 22 is an example including a change value of a notification target, and includes the change value that a notification is “not made”.

In other words, the notification change rule illustrated in FIG. 22 is an example of the notification change rule being set to change the notification setting in such a way that, when an event of “reverse traveling” of “construction vehicle” is detected, a notification of the event is “not made”.

The setting unit 253 performs the change processing. For example, when the automatic generation unit 252 generates a change value, the change unit 253 changes the notification setting by using the change value.

The change notification unit 254 performs the change notification processing. For example, when the change unit 253 changes the notification setting, the change notification unit 254 notifies a user that the change is made.

Except for the points, the road surveillance system according to the example embodiment 2 may be functionally and physical configured similarly to the road surveillance system 100 according to the example embodiment 1.

### (Operation Example of Road Surveillance System According to Present Example Embodiment)

Similarly to the road surveillance system according to the example embodiment 1, the road surveillance system according to the present example embodiment performs road surveillance processing. The road surveillance processing according to the present example embodiment includes capturing processing and image processing similar to those in the example embodiment 1, and surveillance processing different from that in the example embodiment 1.

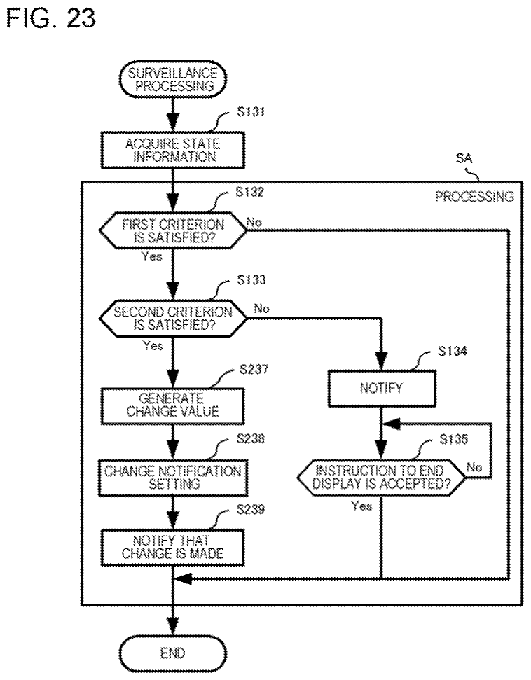

FIG. 23 is a flowchart illustrating one example of the surveillance processing according to the example embodiment 2. The surveillance processing according to the present example embodiment includes steps S237 to S239 instead of steps S136 to S138 according to the example embodiment 1. Except for the points, the surveillance processing according to the present example embodiment may be similar to the surveillance processing according to the example embodiment 1.

When it is determined that the second criterion is satisfied (step S133: Yes), the automatic generation unit 252 generates a change value according to a preset notification change rule, for example (step S237).

The change unit 253 changes notification setting by using the change value generated in step S237 (step S238).

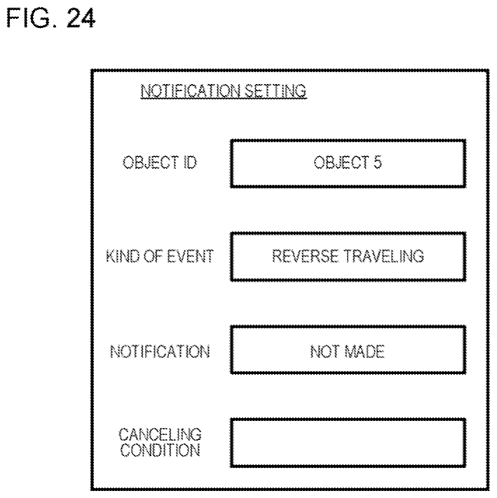

Specifically, for example, it is assumed that the notification change rule illustrated in FIG. 22 is set, and the event 1 illustrated in the example embodiment 1 is detected. In this case, by performing steps S237 to S238, the notification setting is automatically changed to a content illustrated in FIG. 24. Herein, FIG. 24 is a diagram illustrating one example of the notification setting after the change according to the example embodiment 2.

The change notification unit 254 notifies a user that the notification setting is changed in step S238 (step S239).

The notification in step S239 is made by, for example, displaying a message that the notification setting is changed on the display unit 135 for a predetermined period of time. Note that, the notification in step S239 is not limited thereto, and may be appropriately changed.

### (Action and Effect)

As described above, according to the example embodiment 2, the first criterion is a criterion defined in relation to a road state. The notification setting includes setting related to whether to make a notification of the road state that satisfies the first criterion. The change-related processing includes the automatic generation processing of generating a change value for changing notification setting in such a way as to suppress a notification, and the change processing of changing the notification setting by using the change value.

In this way, the notification setting can be automatically changed in such a way as to suppress a notification, and thus the notification setting can be appropriately changed at an appropriate timing. Therefore, efficiency of road surveillance can be improved.

According to the example embodiment 2, the change-related processing further includes the change notification processing of notifying a user that the notification setting is changed based on the change value.

In this way, when the notification setting is automatically changed, the user can recognize that the change is performed. Thus, the user can confirm and reset the changed notification setting as necessary. Therefore, efficiency of road surveillance can be improved.

### Example Embodiment 3

In the example embodiment 1, the example in which the first confirmation processing is performed when the first criterion and the second criterion are satisfied is described. When the first criterion and the second criterion are satisfied, second confirmation processing different from the first confirmation processing may be performed in addition to the first confirmation processing or instead of the first confirmation processing.

In the present example embodiment, an example in which the second confirmation processing is performed in addition to the first confirmation processing when the first criterion and the second criterion are satisfied will be described.

In the present example embodiment, description of a configuration similar to that in the example embodiment 1 will be appropriately omitted for simplifying the description.

A road surveillance system according to an example embodiment 3 includes the road surveillance apparatus including a processing unit 334 instead of the processing unit 134 according to the example embodiment 1.

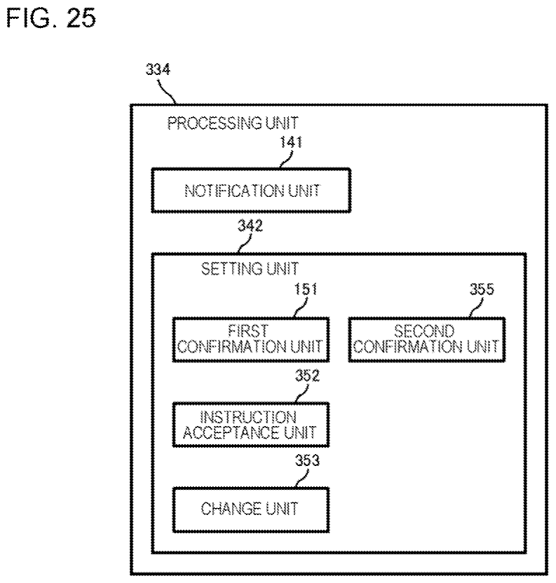

FIG. 25 is a diagram illustrating a functional configuration example of the processing unit 334 according to the example embodiment 3. Similarly to the example embodiment 1, the processing unit 334 performs processing, based on a determination result of a first determination unit 132 and a second determination unit 133. For example, when a road state satisfies a first criterion, the processing unit 334 performs any of notification processing and change-related processing, based on whether a second criterion is satisfied.

The change-related processing according to the present example embodiment includes, for example, first confirmation processing similar to that in the example embodiment 1. In addition, the change-related processing according to the present example embodiment includes, for example, the second confirmation processing, and change processing different from that in the example embodiment 1.

The second confirmation processing is processing for making a confirmation of a change in image processing setting from a user. As described above, the image processing setting includes, for example, at least one of setting indicating a position of a road or a lane in an image, setting indicating an actual distance between reference points in an image, setting indicating a road or a traveling direction determined in each lane on a road, and the like.

The change processing according to the present example embodiment includes processing of changing image processing setting in addition to processing of changing notification setting.

Note that, the notification processing may be similar to that in the example embodiment 1.

As illustrated in FIG. 25, the processing unit 334 includes a notification unit 141 similar to that in the example embodiment 1, and a setting unit 342 instead of the setting unit 142 according to the example embodiment 1.

The setting unit 342 performs the change-related processing according to the present example embodiment. For example, the setting unit 342 performs the change-related processing according to the present example embodiment when the first criterion is satisfied and the second criterion is satisfied.

As illustrated in FIG. 25, the setting unit 342 includes a first confirmation unit 151 similar to that in the example embodiment 1, and an instruction acceptance unit 352 and a change unit 353 instead of the instruction acceptance unit 152 and the change unit 153 according to the example embodiment 1. The setting unit 342 further includes a second confirmation unit 355.

The second confirmation unit 355 performs the second confirmation processing. For example, the second confirmation unit 355 displays a second confirmation screen on a display unit 135 as the second confirmation processing. The second confirmation screen is a screen for making a confirmation of a change in image processing setting from a user.

Similarly to the instruction acceptance unit 152 according to the example embodiment 1, the instruction acceptance unit 352 accepts an instruction by a user (i.e., a user instruction). For example, the instruction acceptance unit 352 according to the present example embodiment accepts a user instruction as a response to the confirmation processing (for example, a first confirmation screen or the second confirmation screen displayed on the display unit 135).

The user instruction includes, for example, an instruction to change image processing setting. The instruction to change the image processing setting may include a content of the image processing setting after the change. The user instruction may include an instruction not to change the image processing setting.

The setting unit 353 performs the change processing. The change processing is processing of changing the notification setting or the image processing setting according to a user instruction for the confirmation processing.

Specifically, when the instruction acceptance unit 152 accepts an instruction to change the image processing setting for the second confirmation processing, the change unit 353 changes the image processing setting according to the user instruction. As described above, the user instruction in this case includes a content of the image processing setting after the change, and thus the change unit 353 may transmit the content of the image processing setting included in the user instruction to the image processing apparatus 102, and cause the image processing apparatus 102 to hold the content.

When the instruction acceptance unit 152 accepts an instruction not to change the image processing setting for the second confirmation processing, the change unit 153 does not change the image processing setting according to the user instruction. As a result, the image processing apparatus 102 continues to hold the image processing setting being held.

Note that, processing performed by the change unit 353 for the first confirmation processing may be similar to that performed by the change unit 153 according to the example embodiment 1.

Except for the points, the road surveillance system according to the example embodiment 3 may be functionally and physical configured similarly to the road surveillance system 100 according to the example embodiment 1.

### (Operation Example of Road Surveillance System According to Present Example Embodiment)

Similarly to the road surveillance system according to the example embodiment 1, the road surveillance system according to the present example embodiment performs road surveillance processing. The road surveillance processing according to the present example embodiment includes capturing processing and image processing similar to those in the example embodiment 1, and surveillance processing different from that in the example embodiment 1.

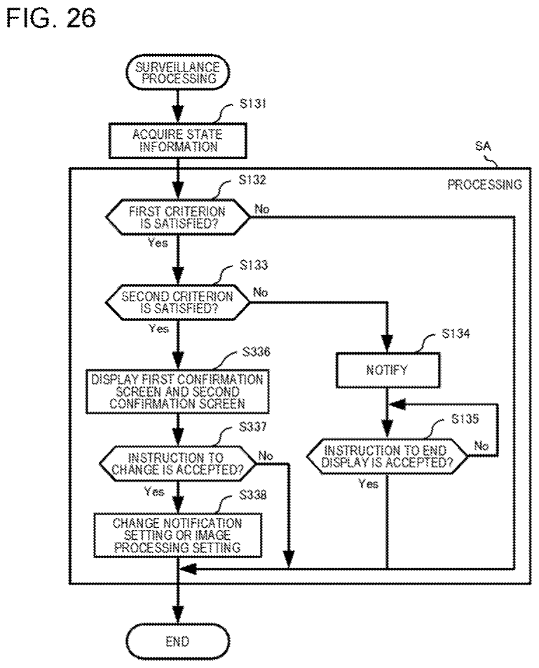

FIG. 26 is a flowchart illustrating one example of the surveillance processing according to the example embodiment 3. The surveillance processing according to the present example embodiment includes steps S336 to S338 instead of steps S136 to S138 according to the example embodiment 1. Except for the points, the surveillance processing according to the present example embodiment may be similar to the surveillance processing according to the example embodiment 1.

When it is determined that the second criterion is satisfied (step S133: Yes), the first confirmation unit 151 and the second confirmation unit 355 respectively display the first confirmation screen and the second confirmation screen on the display unit 135 (step S336).

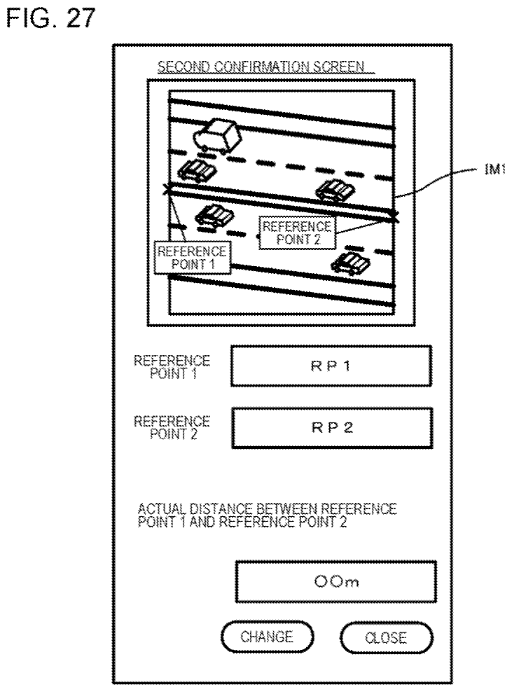

FIG. 27 is a diagram illustrating one example of the second confirmation screen according to the example embodiment 3. The second confirmation screen illustrated in FIG. 27 is an example of a screen for making a confirmation of setting indicating an actual distance between reference points in an image from a user. Note that, the second confirmation screen is not limited thereto, and may be appropriately changed.

The second confirmation screen illustrated in FIG. 27 includes an image indicating a first reference point and a second reference point being currently set for an image (for example, an image IM1) acquired by capturing by a capturing apparatus 101, and a currently set actual distance between the first reference point and the second reference point. Further, the second confirmation screen illustrated in FIG. 27 includes a position (for example, a pixel position) in the currently set image of each of the first reference point and the second reference point being currently set.

For each of the first reference point and the second reference point, for example, a user can input a position to the second confirmation screen by using the image. For the actual distance, for example, the user can input a value to the second confirmation screen.

FIG. 26 is referred again.

The change unit 353 determines whether the instruction acceptance unit 152 has accepted an instruction to change notification setting or image processing setting (step S337).

When the instruction to change the notification setting is accepted, the change unit 353 may perform processing similar to that performed by the change unit 153 according to the example embodiment 1. Thus, in the present example embodiment, processing when the instruction to change the image processing setting is accepted will be described.

In the example of the second confirmation screen illustrated in FIG. 27, the change unit 353 determines that the instruction to change the image processing setting is accepted when information indicating a first reference point, a second reference point, and an actual distance therebetween is input (instructed), and a “change” button is then pressed. The instruction includes the information input to the second confirmation screen. Further, in the example of the second confirmation screen illustrated in FIG. 27, the change unit 353 determines that the instruction to change the image processing setting is not accepted when a “close” button is pressed.

Note that, when the “change” button of one of the first confirmation screen and the second confirmation screen is pressed, the change unit 353 may close the other screen. In this way, the change unit 353 accepts only an instruction of a change associated with a screen on which the “change” button is pressed among the notification setting and the image processing setting. Thus, competition between the instruction to change the notification setting and the instruction to change the image processing setting can be prevented.

FIG. 26 is referred again.

When it is determined that the instruction to change the notification setting and the image processing setting is not accepted (step S337: No), the change unit 353 closes the first confirmation screen and the second confirmation screen, and ends the surveillance processing.

When it is determined that the instruction to change the notification setting or the image processing setting is accepted (step S337: Yes), the change unit 353 changes the notification setting or the image processing setting according to a content of the notification setting or the image processing setting after a change included in the instruction (step S338). Then, the change unit 353 ends the surveillance processing.

When there is an event detected for a predetermined number of times or more or with a predetermined frequency or more, such surveillance processing can prompt a user to confirm the image processing setting. Then, the user can change the image processing setting as necessary.

In general, an orientation (angle of view) of a camera may be changed by maintenance of the capturing apparatus 101, or the image processing setting may be changed (for example, initialized) by update of software.

For example, when a position of a road or a lane is recognized offset, there is a possibility that reverse traveling of a vehicle may be detected by mistake. For example, when one lane is recognized as another lane on a road with the two lanes whose traveling directions are opposite directions to each other, a vehicle is recognized to be traveling in the another lane when the vehicle is traveling in the one lane. As a result, even when the vehicle is traveling in the one lane in a correct direction, there is a possibility that the vehicle may be determined to be reverse traveling.

Further, for example, when a false actual distance is set, there is a possibility that a false vehicle velocity may be obtained.

In such a case, a false notification may be repeated.

When there is an event detected for a predetermined number of times or more or with a predetermined frequency or more, by prompting a user to confirm the image processing setting, the user can quickly recognize an error in the setting and change the setting to a correct content. Therefore, efficiency of road surveillance can be improved.

### (Action and Effect)

As described above, according to the example embodiment 3, the change-related processing includes the second confirmation processing of displaying, on the display unit 135, the second confirmation screen for making a confirmation related to a change in the image processing setting being setting related to processing of an image from a user.

In this way, the user can easily recognize an advantage of making a confirmation related to a change in the image processing setting by viewing the second confirmation screen. Therefore, efficiency of road surveillance can be improved.

According to the example embodiment 3, the image processing setting includes a set value related to at least one of a position of a road or a lane in an image, and an actual distance between reference points in the image.

In this way, a possibility of false detection due to a defect in the image processing setting can be reduced. Therefore, efficiency of road surveillance can be improved.

### Example Embodiment 4

In the example embodiment 1, the example in which the road surveillance system includes one capturing apparatus 101, one image processing apparatus 102, and one road surveillance apparatus 103 is described. However, the road surveillance system may include a plurality of the capturing apparatuses 101 installed in such a way as to capture a different place on a road. The road in this case may be a specific road such as an X expressway, or may include a plurality of specific roads such as the X expressway and a Y expressway. Note that, a road may include a passage of a person.

Further, the road surveillance system may include a plurality of the image processing apparatuses 102. In this case, each of the image processing apparatuses 102 may be connected to one or the plurality of capturing apparatuses 101 via a network N in such a way as to be able to transmit and receive information to and from each other. In this way, each of the image processing apparatuses 102 can detect a road state being a state of an object on a road by processing an image in which one or the plurality of capturing apparatuses 101 capture the road.

Note that, such a change is also applicable to the example embodiments 2 to 3.

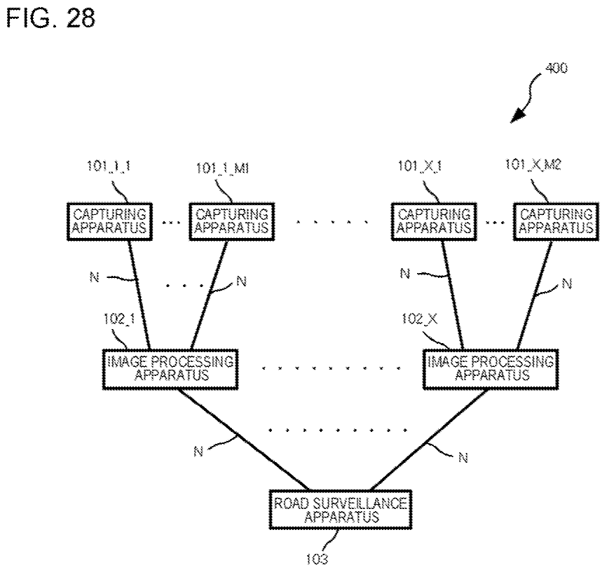

FIG. 28 is a diagram illustrating a configuration example of a road surveillance system 400 according to an example embodiment 4. The road surveillance system 400 includes a plurality of capturing apparatuses 101_1_1 to 101_1_M1 and 101_X_1 to 101_X_M2, one or a plurality of image processing apparatuses 102_1 to 102_X, and a road surveillance apparatus 103. Each of M1, M2, and X is an integer equal to or more than one.

The plurality of capturing apparatuses 101_1 _1 to 101_1_M1 and 101_X_1 to 101_X_M2 are installed in such a way as to capture a different place on a road. Each of the plurality of capturing apparatuses 101_1_1 to 101_1_M1 and 101_X_1 to 101_X_M2 corresponds to, for example, the capturing apparatus 101 according to the example embodiment 1. Thus, the plurality of capturing apparatuses 101_1_1 to 101_1_M1 and 101_X_1 to 101_X_M2 generate a plurality of images in which a different place on a road is captured.

When X is equal to or more than two, each of the image processing apparatuses 102_1 to 102_X corresponds to the image processing apparatus 102 according to the example embodiment 1. For example, in each of the image processing apparatuses 102_1 to 102_X according to the present example embodiment, an image acquisition unit 121 acquires one or a plurality of images from one or the plurality of capturing apparatuses 101_1_1 to 101_1_M1 and 101_X_1 to 101_X_M2. A detection unit 122 of each of the image processing apparatuses 102_1 to 102_X detects a road state by processing one or the plurality of images acquired by the image acquisition unit 121, and generates state information.

A road state acquisition unit 131 according to the present example embodiment acquires the state information from one or the plurality of image processing apparatuses 102. For example, a first determination unit 132 may determine whether each of road states included in one or a plurality of pieces of the state information satisfies a first criterion.

Since there are the plurality of capturing apparatuses 101_1_1 to 101_1_M1 and 101_X_1 to 101_X_M2, the first determination unit 132 may determine each of the plurality of road states detected based on each of the plurality of images, for example.

### (Action and Effect)

As described above, according to the example embodiment 4, an image includes a plurality of images in which a different place on a road is captured. The detection unit 122 may be one or plural. Each of the detection units 122 detects a road state by processing the plurality of images.

In this way, the road surveillance system 400 can detect a road state, based on the plurality of images in which the different place on the road is captured. Thus, similarly to the example embodiment 1, efficiency of road surveillance can be improved, and the like.

### Example Embodiment 5

In the example embodiment 1, the example in which the notification setting is changed by a content instructed by a user is described.

In general, some events frequently occur at a specific timing or in a specific region (place), such as congestion of vehicles. In a case of congestion frequently occurring at a specific timing or in a specific region, a user who performs road surveillance is more likely to be able to make prediction, based on experience. A notification of this may cause a repetitive confirmation of a predictable event, and reduce efficiency of road surveillance.

According to the example embodiment 1, for example, by specifying at least one of a timing and a region by a user, a notification of congestion frequently occurring at the specific timing or in the specific region can be suppressed. For example, as in a case where an object ID is not set in the notification setting illustrated in FIG. 10, a user may specify at least one of a timing and a region, a kind of an event, a notification manner, and the like on a screen for performing the notification setting such as the first confirmation screen, and may set a content thereof as the notification setting. In this way, a notification of an event frequently occurring at a specific timing and in a specific region can be suppressed, and thus efficiency of road surveillance can be improved.

Herein, the timing is, for example, a date attribute, time (a time period or a time), and the like. The date attribute is an attribute related to a date such as a day of the week, and a weekday or a weekend (for example, Saturday, Sunday, and a holiday).

Further, the notification setting may be automatically changed in order to suppress a notification of an event frequently occurring at a specific timing and in a specific region. In the present example embodiment, an example in which the notification setting is automatically changed based on a history of an event will be described.

In the present example embodiment, description of a configuration similar to that in the example embodiment 1 will be appropriately omitted for simplifying the description.

A road surveillance system according to an example embodiment 5 includes a road surveillance apparatus including a processing unit 534 instead of the processing unit 134.

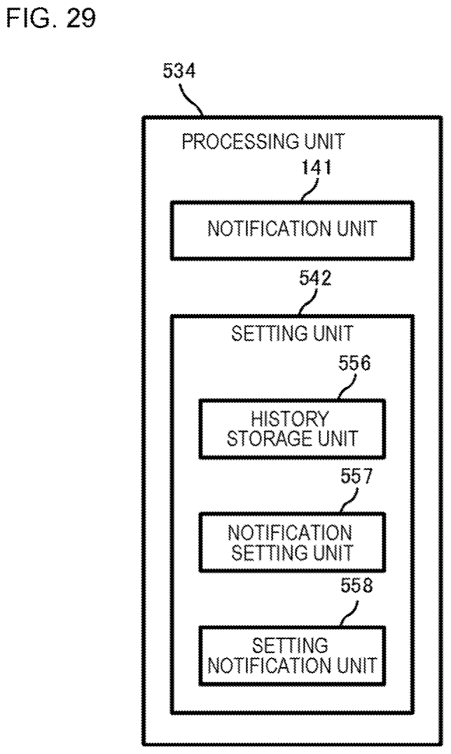

FIG. 29 is a diagram illustrating a functional configuration example of the processing unit 534 according to the example embodiment 5. Similarly to the example embodiment 1, the processing unit 534 performs processing, based on a determination result of a first determination unit 132 and a second determination unit 133. For example, when a road state satisfies a first criterion, the processing unit 534 performs any of notification processing and change-related processing, based on whether a second criterion is satisfied.

The change-related processing according to the present example embodiment includes notification setting processing. Further, the change-related processing according to the present example embodiment may further include setting notification processing.

The notification setting processing is processing for automatically setting notification setting, based on a history of an event. The setting notification processing is processing for notifying that the notification setting is automatically set.

As illustrated in FIG. 29, the processing unit 534 includes a notification unit 141 similar to that in the example embodiment 1, and a setting unit 542 instead of the setting unit 142 according to the example embodiment 1.

The setting unit 542 performs the change-related processing according to the present example embodiment when, for example, a history of an event satisfies the second criterion.

Herein, the second criterion according to the present example embodiment may include, for example, a condition related to a region in addition to a frequency and the number of times. Specifically, for example, the second criterion according to the present example embodiment is that an event of the same kind is repeatedly detected with a frequency equal to or more than a predetermined value or for the number of times equal to or more than a predetermined value at a predetermined timing or in a predetermined region.

The frequency herein may be, for example, the number of times in a predetermined period by one or a plurality of combinations of a date attribute, a time period, and a time. Further, the number of times may be, for example, the number of times by one or a plurality of combinations of a date attribute, a time period, and a time. A specific content of the second criterion may be set by a user, for example.

As illustrated in FIG. 29, the setting unit 542 includes a history storage unit 556, a notification setting unit 557, and a setting notification unit 558.

The history storage unit 556 stores history information indicating a history of an event (i.e., a road state that satisfies the first criterion). The history information includes a kind of an event, and a region and a timing at which the event occurs.

For example, when a road state is determined to satisfy the first criterion, the first determination unit 132 may generate history information about the road state that satisfies the first criterion, and store the history information in the history storage unit 556.

Note that, the history information may include at least one of a kind of an event, a region in which the event occurs, and a timing at which the event occurs, and the timing may include at least one of a date attribute, a time period, and a time.

The notification setting unit 557 automatically sets a notification change rule, based on the history of the event.

Specifically, for example, the notification setting unit 557 creates notification setting, based on the history of the event stored in the history storage unit 556. At this time, the notification setting unit 557 may further refer to the second criterion. In this case, for example, the notification setting unit 557 creates the notification setting, based on an event that satisfies the second criterion in the history of the event, and sets the created notification setting.

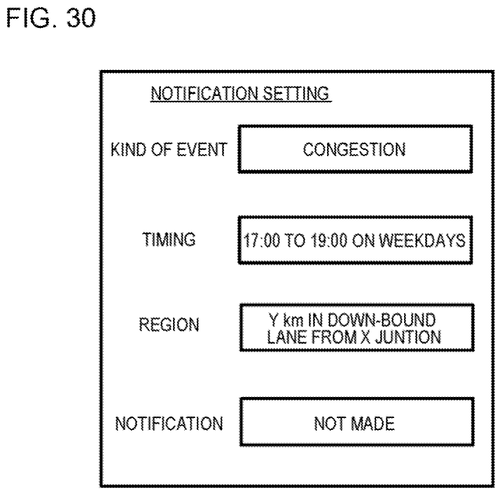

FIG. 30 is a diagram illustrating one example of the notification setting according to the example embodiment 5.

The notification setting illustrated in FIG. 30 is an example of the notification setting for a kind of an event “congestion”. FIG. 30 illustrates an example of the notification setting having a content that, when “congestion” occurs at a timing of “17:00 to 19:00” on “weekdays” in a region of “Y km (kilometers) in down-bound lane from X junction”, a notification is “not made”.

Note that, the notification setting is not limited to that illustrated in FIG. 30, and may be appropriately changed by deleting or adding an item, and the like. For example, setting that a notification is “not made” is one example of setting of a notification manner, and a notification frequency may be set in the setting.

The setting notification unit 558 performs the setting notification processing. For example, when the notification setting unit 557 sets the notification setting, the setting notification unit 558 notifies a user that the setting is performed.

Except for the points, the road surveillance system according to the example embodiment 5 may be functionally and physical configured similarly to the road surveillance system 100 according to the example embodiment 1.

### (Operation Example of Road Surveillance System According to Present Example Embodiment)

Similarly to the road surveillance system according to the example embodiment 1, the road surveillance system according to the present example embodiment performs road surveillance processing. The road surveillance processing according to the present example embodiment includes capturing processing and image processing similar to those in the example embodiment 1, the notification setting processing, and surveillance processing different from that in the example embodiment 1.

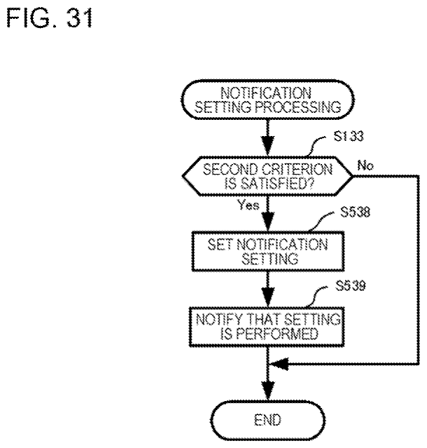

FIG. 31 is a flowchart illustrating one example of the notification setting processing according to the example embodiment 5. The notification setting processing is processing for automatically setting notification setting. The notification setting processing is performed at a predetermined timing such as a predetermined time everyday, a predetermined time once in a week, and a predetermined date and time once in a month, for example.

The second determination unit 133 determines whether a history of an event satisfies the second criterion (step S133).

Specifically, for example, the second determination unit 133 refers to the history storage unit 556, and determines whether there is an event that satisfies the second criterion in history information.

When it is determined that the second criterion is not satisfied (step S133; No), the second determination unit 133 ends the notification setting processing.

When it is determined that the second criterion is satisfied (step S133; Yes), the notification setting unit 557 creates notification setting, based on the event that satisfies the second criterion among events included in the history information, and causes the notification unit 141 to hold the created notification setting. In this way, the notification setting unit 557 sets the notification setting (step S538).

Specifically, for example, the history information is assumed to include, with a predetermined frequency or more, a history of congestion occurring from 17:00 to 19:00 on weekdays within Y km in a down-bound lane from an X junction. In this case, the notification setting unit 557 may set the notification setting illustrated in FIG. 30, based on the history of the congestion.

Note that, in the notification setting, a specific setting content of a notification manner such as whether to set a notification to be “not made” and whether to set a notification frequency may be predetermined, or may be specified by a user.

The setting notification unit 558 notifies a user that the notification setting is set in step S538 (step S539), and ends the notification setting processing.

By performing such notification setting processing, the notification setting can be automatically set in order to suppress a notification of an event frequently occurring at a specific timing and in a specific region.

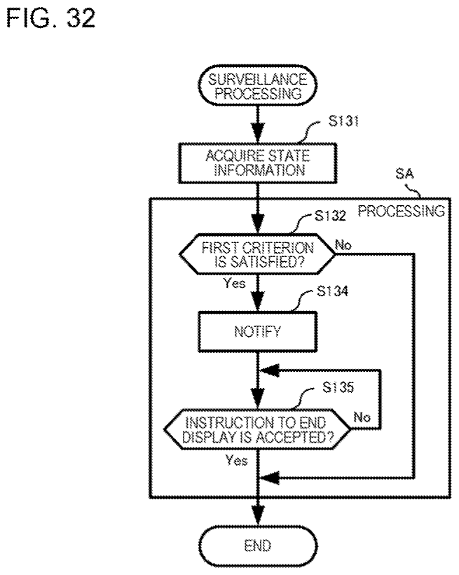

FIG. 32 is a flowchart illustrating one example of the surveillance processing according to the example embodiment 5. The surveillance processing according to the present example embodiment includes steps S131 to S132 similar to those in the example embodiment 1. Then, when it is determined that the first criterion is satisfied in step S132 (step S132; Yes), steps S134 to S135 similar to those in the example embodiment 1 are performed.

By performing such surveillance processing, a notification of an event can be made according to notification setting being automatically set.

Note that, in the surveillance processing according to the present example embodiment, for example, steps S538 to S539 may be performed instead of steps S136 to S138 (see FIG. 18) according to the example embodiment 1. In this case, the notification setting processing may not be performed.

### (Action and Effect)

As described above, according to the example embodiment 5, the road surveillance apparatus includes the notification setting unit 557 that automatically sets a notification change rule, based on a history of an event.

By performing such surveillance processing, a notification of an event frequently occurring at a specific timing and in a specific region can be suppressed. Therefore, efficiency of road surveillance can be improved.

While the example embodiments and the modification examples of the present invention have been described with reference to the drawings, the example embodiments and the modification examples are only exemplification of the present invention, and various configurations other than the above-described example embodiments and modification examples can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, the example embodiments and the modification examples described above can be combined within an extent that a content is not inconsistent.

A part or the whole of the above-described example embodiment may also be described in supplementary notes below, which is not limited thereto.

1. A road surveillance system including:
a detection means for detecting a road state being a state of an object on a road by processing an image in which the road is captured; and
a processing means for performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

2. The road surveillance system according to supplementary note 1, wherein
the processing means includes
   a notification means for performing the notification processing when the first criterion is satisfied, and
   a setting means for performing the change-related processing when the first criterion is satisfied and the second criterion is satisfied.

3. The road surveillance system according to supplementary note 2, wherein
the notification means performs the notification processing when the first criterion is satisfied and the second criterion is not satisfied.

4. The road surveillance system according to any one of supplementary notes 1 to 3, wherein
the change-related processing includes first confirmation processing of displaying, on a display means, a first confirmation screen for making a confirmation related to a change in the notification setting from a user.

5. The road surveillance system according to supplementary note 4, wherein
the first confirmation screen includes the image associated with a road state determined to satisfy the first criterion, and an indicator for identifying each object included in the image.

6. The road surveillance system according to supplementary note 5, wherein
the object includes a vehicle,
the road state includes an attribute of the vehicle, and
the first confirmation screen further includes an attribute of the vehicle.

7. The road surveillance system according to any one of supplementary notes 4 to 6, wherein
the first criterion is a criterion defined in relation to the road state,
the notification setting includes setting related to whether to make a notification of a road state that satisfies the first criterion, and
the change-related processing includes change processing of changing the notification setting according to a user instruction for the confirmation processing.

8. The road surveillance system according to any one of supplementary notes 1 to 3, wherein
the first criterion is a criterion defined in relation to the road state,
the notification setting includes setting related to whether to make a notification of a road state that satisfies the first criterion, and
the change-related processing includes automatic generation processing of generating a change value for changing the notification setting in such a way as to suppress the notification, and change processing of changing the notification setting by using the change value.

9. The road surveillance system according to supplementary note 8, wherein
the change-related processing further includes change notification processing of notifying a user that the notification setting is changed based on the change value.

10. The road surveillance system according to any one of supplementary notes 7 to 9, wherein
the notification setting includes a canceling condition of a setting content.

11. The road surveillance system according to any one of supplementary notes 1 to 10, wherein
the second criterion includes a criterion defined in relation to the number of times or a frequency with which the road state is determined to satisfy the first criterion.

12. The road surveillance system according to any one of supplementary notes 1 to 11, wherein
the change-related processing includes second confirmation processing of displaying, on a display means, a second confirmation screen for making a confirmation related to a change in image processing setting being setting related to processing of the image from a user.

13. The road surveillance system according to any one of supplementary notes 1 to 12, wherein
the image processing setting includes a set value related to at least one of a position of a road or a lane in an image, and an actual distance between reference points in the image.

14. The road surveillance system according to any one of supplementary notes 1 to 13, wherein
the image includes a plurality of images in which a different place on a road is captured,
the detection means is one or plural, and
each of the detection means detects the road state by processing the plurality of images.

15. A road surveillance apparatus including:
a road state acquisition means for acquiring state information including a road state being a state of an object on a road; and
a processing means for performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

16. A road surveillance method including,
by one or more computers:
acquiring state information including a road state being a state of an object on a road; and
performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

17. A program causing one or more computers to execute:
acquiring state information including a road state being a state of an object on a road; and
performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

18. A storage medium storing a program causing one or more computers to execute:
acquiring state information including a road state being a state of an object on a road; and
performing, when the road state satisfies a first criterion, any of notification processing of making a notification of the road state that satisfies the first criterion according to notification setting related to the notification, and change-related processing related to a change in the notification setting, based on whether a second criterion is satisfied, wherein
the second criterion is a criterion related to a determination result of whether the road state satisfies the first criterion.

What is claimed is:

1. A road surveillance system comprising:
at least one memory configured to store instructions; and
at least one processor configured to execute the instructions to execute:
detecting a road state being a state of an object on a road by processing an image in which the road is captured; and
performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

2. The road surveillance system according to claim 1, wherein
performing, any of the notification processing includes
performing the notification processing when the first criterion is satisfied, and
performing the change-related processing when the first criterion is satisfied and the second criterion is satisfied.

3. The road surveillance system according to claim 2, wherein
the notification processing is performed when the first criterion is satisfied and the second criterion is not satisfied.

4. The road surveillance system according to claim 1, wherein
the change-related processing includes first confirmation processing of displaying, on display, a first confirmation screen for making a confirmation related to a change in the notification setting from a user.

5. The road surveillance system according to claim 4, wherein
the first confirmation screen includes the image associated with a road state determined to satisfy the first criterion, and an indicator for identifying each object included in the image.

6. The road surveillance system according to claim 5, wherein
the object includes a vehicle,
the road state includes an attribute of the vehicle, and
the first confirmation screen further includes an attribute of the vehicle.

7. The road surveillance system according to claim 1, wherein
the change-related processing includes second confirmation processing of displaying, on display, a second confirmation screen for making a confirmation related to a change in image processing setting being setting related to processing of the image from a user.

8. A road surveillance method comprising,
by one or more computers:
acquiring state information including a road state being a state of an object on a road; and
performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

9. The road surveillance method according to claim 8, wherein
performing, any of the notification processing includes
performing the notification processing when the first criterion is satisfied, and
performing the change-related processing when the first criterion is satisfied and the second criterion is satisfied.

10. The road surveillance method according to claim 9, wherein
the notification processing is performed when the first criterion is satisfied and the second criterion is not satisfied.

11. The road surveillance method according to claim 8, wherein
the change-related processing includes first confirmation processing of displaying, on display, a first confirmation screen for making a confirmation related to a change in the notification setting from a user.

12. The road surveillance method according to claim 11, wherein
the first confirmation screen includes the image associated with a road state determined to satisfy the first criterion, and an indicator for identifying each object included in the image.

13. The road surveillance method according to claim 12, wherein
the object includes a vehicle,
the road state includes an attribute of the vehicle, and
the first confirmation screen further includes an attribute of the vehicle.

14. The road surveillance method according to claim 8, wherein
the change-related processing includes second confirmation processing of displaying, on display, a second confirmation screen for making a confirmation related to a change in image processing setting being setting related to processing of the image from a user.

15. A non-transitory storage medium storing program causing one or more computers to execute:
acquiring state information including a road state being a state of an object on a road; and
performing, when the road state satisfies a first criterion, any of notification processing of making a notification of the road state that satisfies the first criterion according to notification setting related to the notification, and change-related processing related to a change in the notification setting of the notification, based on whether a second criterion is satisfied, wherein
the second criterion is a criterion related to a determination result of whether the road state satisfies the first criterion.

16. The non-transitory storage medium storing the program according to claim 15, wherein
performing, any of the notification processing includes
performing the notification processing when the first criterion is satisfied, and
performing the change-related processing when the first criterion is satisfied and the second criterion is satisfied.

17. The non-transitory storage medium storing the program according to claim 16, wherein
the notification processing is performed when the first criterion is satisfied and the second criterion is not satisfied.

18. The non-transitory storage medium storing the program according to claim 15, wherein
the change-related processing includes first confirmation processing of displaying, on display, a first confirmation screen for making a confirmation related to a change in the notification setting from a user.

19. The non-transitory storage medium storing the program according to claim 18, wherein
the first confirmation screen includes the image associated with a road state determined to satisfy the first criterion, and an indicator for identifying each object included in the image.

20. The non-transitory storage medium storing the program according to claim 19, wherein
the object includes a vehicle,
the road state includes an attribute of the vehicle, and
the first confirmation screen further includes an attribute of the vehicle.
